(19) United States
(12) Patent Application Publication
(10) Pub. No.: US 2024/0106113 A1
(43) Pub. Date: Mar. 28, 2024

(54) APPARATUS FOR PROCESSING RADIO FREQUENCY SIGNALS

(71) Applicant: NOKIA SHANGHAI BELL CO., LTD., Shanghai (CN)

(72) Inventors: Aurelien HILARY, Paimpol (FR); Thomas JULIEN, Lannion (FR); Ronan CHAUME, Cavan (FR); Gilles COQUILLE, Begard (FR); Bilal ELJAAFARI, Rennes (FR); Jean-Pierre HAREL, Lannion (FR)

(73) Assignee: NOKIA SHANGHAI BELL CO., LTD., Shanghai (CN)

(21) Appl. No.: 18/257,398

(22) PCT Filed: Dec. 23, 2020
(86) PCT No.: PCT/CN2020/138673

§ 371 Date: Jun. 14, 2023

(51) Int. Cl. H01Q 3/32; H01P 1/18

(52) U.S. Cl. CPC H01Q 3/32; H01P 1/184

(57) ABSTRACT

An apparatus for processing radio frequency signals, comprising a first phase shifting stage configured to receive an RF signal and to provide n1 many, with n1>=2, phase-shifted portions of the RF signal, and at least a second phase shifting stage configured to receive the n1 many phase-shifted portions of the RF signal and to provide n2 many, with n2>=n1, phase-shifted portions of the RF signal based on the received n1 many phase-shifted portions of the RF signal, wherein a phase shift applied by the second phase shifting stage to the n1 many phase-shifted portions of the RF signal is based on at least one phase shift applied by the first phase shifting stage to the n1 many phase-shifted portions of the RF signal with respect to the RF signal.

### FIELD OF THE DISCLOSURE

The disclosure relates to an apparatus for processing radio frequency, RF, signals.

The disclosure further relates to a method of processing radio frequency, RF, signals.

### BACKGROUND

Apparatus for processing RF signals may for example be used for processing RF signals that are provided for transmission via an antenna.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus for processing radio frequency signals, comprising a first phase shifting stage configured to receive an RF signal and to provide n1 many, with n1>=2, phase-shifted portions of the RF signal, and at least a second phase shifting stage configured to receive the n1 many phase-shifted portions of the RF signal and to provide n2 many, with n2>=n1, phase-shifted portions of the RF signal based on the received n1 many phase-shifted portions of the RF signal, wherein a phase shift applied by the second phase shifting stage to the n1 many phase-shifted portions of the RF signal is based on at least one phase shift applied by the first phase shifting stage to the n1 many phase-shifted portions of the RF signal with respect to the RF signal.

In some embodiments, the first phase shifting stage is configured to apply a positive phase shift by a first phase shift value to at least a first portion of the radio signal to obtain a first phase-shifted portion of the RF signal and to apply a negative phase shift by the first phase shift value to at least a second portion of the radio signal to obtain a second phase-shifted portion of the RF signal.

In some embodiments, the second phase shifting stage is configured to apply a positive phase shift by a second phase shift value to at least a first portion of the first phase-shifted portion of the RF signal and to apply a negative phase shift by the second phase shift value to at least a second portion of the first phase-shifted portion of the RF signal.

In some embodiments, the second phase shift value is a multiple or a fraction of the first phase shift value.

In some embodiments, the first phase shifting stage and the second phase shifting stage each comprises at least one phase shifter module configured to split an input signal into at least two phase shifted output signals.

In some embodiments, the phase shifter module comprises a first port for receiving the input signal, a second port for providing a first one of the at least two output signals, and a third port for providing a second one of the at least two output signals, wherein the phase shifter module further comprises at least one coupling element arranged movably, for example slidably, with respect to the first port, the second port and the third port, the at least one coupling element coupling the first port with the second port and the third port with a predetermined phase shift based on a relative position of the at least one coupling element with respect to the first port.

In some embodiments, the apparatus is configured to move a coupling element of the phase shifter module of the first phase shifting stage and a coupling element of the phase shifter module of the second phase shifting stage at different speeds.

In some embodiments, each one of the first port and the second port and the third port is assigned a respective transmission line segment, wherein the coupling element is configured to establish an electromagnetic, for example capacitive, coupling between the transmission line segment associated with the first port and the transmission line segment associated with the second port and between the transmission line segment associated with the first port and the transmission line segment associated with the third port.

In some embodiments, the apparatus is configured to move coupling elements of the phase shifter module of the first phase shifting stage with a same relative speed with respect to coupling elements of phase shifter modules of the second phase shifting stage.

In some embodiments, the apparatus comprises a drive system for driving a movement of the coupling elements.

In some embodiments, the drive system comprises a lever-arm system having a plurality of arms, wherein each arm is coupled to one or more coupling elements of a same phase shifting stage, and wherein the arms are rotatably connected to at least one lever.

In some embodiments, the apparatus is configured to move a) the at least one lever and/or b) at least one of the plurality of arms to drive a movement of the plurality of arms.

In some embodiments, the drive system comprises a pulley system having a plurality of pulleys, wherein each pulley is coupled to one or more coupling elements of a same phase shifting stage, and wherein the apparatus is configured to drive different pulleys at a respective different speed.

In some embodiments, at least one pulley of the plurality of pulleys comprises a wire for driving a movement of one or more coupling elements of a same phase shifting stage.

In some embodiments, the drive system comprises a rack and pinion system having a plurality of racks, wherein each rack is coupled to one or more coupling elements of a same phase shifting stage, wherein the apparatus is configured to drive different racks at a respective different speed.

In some embodiments, the apparatus further comprises an enclosure, wherein the enclosure comprises at least a first part and a second part, wherein the first part is connected to the second part via a connecting element configured to provide a capacitive coupling between the first part and the second part.

In some embodiments, the connecting element comprises a printed circuit board having a plurality of electrically conductive vias, at least one electrically conductive layer connected to the plurality of electrically conductive vias, and at least one electrically insulating layer arranged on the at least one electrically conductive layer.

In some embodiments, the printed circuit board comprises at least one opening.

In some embodiments, the apparatus further comprises at least two printed circuit boards mechanically connectable and/or connected to each other using form closure.

Some embodiments relate to a phase shifter comprising at least one apparatus according to the embodiments.

Some embodiments relate to a method for processing radio frequency signals using an apparatus comprising a first phase shifting stage configured to receive an RF signal and to provide n1 many, with n1>=2, phase-shifted portions of the RF signal, and at least a second phase shifting stage configured to receive the n1 many phase-shifted portions of the RF signal and to provide n2 many, with n2>=n1, phase-shifted portions of the RF signal based on the received n1 many phase-shifted portions of the RF signal, the method comprising: receiving, by means of the first phase shifting stage, an RF signal, providing, by means of the first phase shifting stage, n1 many phase-shifted portions of the RF signal, wherein a phase shift applied by the second phase shifting stage to the n1 many phase-shifted portions of the RF signal is based on at least one phase shift applied by the first phase shifting stage to the n1 many phase-shifted portions of the RF signal with respect to the RF signal.

### BRIEF DESCRIPTION OF THE FIGURES

Further features, aspects and advantages of the illustrative embodiments are given in the following detailed description with reference to the drawings in which:

FIG. 1 schematically depicts a simplified block diagram of an apparatus according to some embodiments,

FIG. 2 schematically depicts a simplified block diagram according to some embodiments,

FIG. 3A schematically depicts a simplified block diagram according to some embodiments,

FIG. 3B schematically depicts a simplified block diagram according to some embodiments,

FIG. 4 schematically depicts a simplified flow chart according to some embodiments,

FIG. 5 schematically depicts a simplified flow chart according to some embodiments,

FIG. 6 schematically depicts a simplified flow chart according to some embodiments,

FIG. 7 schematically depicts a simplified block diagram according to some embodiments,

FIG. 8 schematically depicts a simplified top view of a phase shifter module according to some embodiments,

FIG. 9 schematically depicts aspects of a coupling element according to some embodiments,

FIG. 10 schematically depicts a simplified top view of a phase shifter according to some embodiments,

FIG. 11A schematically depicts a simplified top view of an apparatus according to some embodiments in a first operational state,

FIG. 11B schematically depicts a simplified top view of the apparatus of FIG. 11A in a second operational state,

FIG. 11C schematically depicts a simplified top view of the apparatus of FIG. 11A in a third operational state,

FIG. 12A schematically depicts a simplified top view of an apparatus according to some embodiments in a first operational state,

FIG. 12B schematically depicts a simplified top view of the apparatus of FIG. 12A in a second operational state,

FIG. 12C schematically depicts a simplified top view of the apparatus of FIG. 12A in a third operational state,

FIG. 12D schematically depicts a perspective view of the apparatus according to FIG. 12A,

FIG. 13 schematically depicts a simplified block diagram of aspects of a drive system according to some embodiments,

FIG. 14 schematically depicts a simplified perspective view of a drive system according to some embodiments,

FIG. 15A schematically depicts aspects of a drive system according to some embodiments in a first operational state,

FIG. 15B schematically depicts aspects of the drive system of FIG. 15A in a second operational state,

FIG. 15C schematically depicts aspects of the drive system of FIG. 15A in a perspective view,

FIG. 15D schematically depicts a simplified perspective view of a detail of the drive system of FIG. 15A,

FIG. 16A schematically depicts a simplified top view of an apparatus according to some embodiments in a first operational state,

FIG. 16B schematically depicts a simplified top view of the apparatus of FIG. 16A in a second operational state,

FIG. 17 schematically depicts a simplified side view of an apparatus according to some embodiments,

FIG. 18 schematically depicts a simplified partial cross-sectional side view of an apparatus according to some embodiments,

FIG. 19 schematically depicts a simplified top view of a connecting element according to some embodiments,

FIG. 20 schematically depicts a simplified partial cross-sectional side view of a connecting element according to some embodiments,

FIG. 21 schematically depicts a simplified perspective view of a connecting element according to some embodiments,

FIG. 22 schematically depicts a simplified partial cross-sectional side view of a connecting element according to some embodiments,

FIG. 23 schematically depicts a simplified top view of a connecting element according to some embodiments,

FIG. 24 schematically depicts a simplified perspective view of a connecting element with cables attached according to some embodiments,

FIG. 25 schematically depicts a simplified perspective view of a connecting element with cables attached according to some embodiments,

FIG. 26 schematically depicts a simplified perspective view of a connecting element with cables attached according to some embodiments,

FIG. 27A schematically depicts a simplified front view of a housing according to some embodiments,

FIG. 27B schematically depicts a simplified front view of the housing of FIG. 27A with a printed circuit board according to some embodiments,

FIG. 28A schematically depicts a simplified front view of a housing according to some embodiments,

FIG. 28B schematically depicts a simplified front view of the housing of FIG. 28A with a printed circuit board according to some embodiments,

FIG. 29 schematically depicts a top view of a phase shifter arrangement according to some embodiments,

FIG. 30A schematically depicts the phase shifter arrangement of FIG. 29 in a first state,

FIG. 30B schematically depicts the phase shifter arrangement of FIG. 29 in a second state,

FIG. 31 schematically depicts a printed circuit board according to some embodiments,

FIG. 32 schematically depicts printed circuit boards according to some embodiments,

FIG. 33A schematically depicts a diagram of a scattering parameter over frequency according to some embodiments,

FIG. 33B schematically depicts a diagram of a scattering parameter over frequency according to some embodiments,

FIG. 34 schematically depicts a perspective view of aspects of an apparatus according to some embodiments,

FIG. 35 schematically depicts a perspective view of aspects of an apparatus according to some embodiments,

FIG. 36 schematically depicts a top view of aspects of an apparatus according to some embodiments,

FIG. 37 schematically depicts a side view of aspects of an apparatus according to some embodiments,

FIG. 38 schematically depicts a side view of an apparatus according to some embodiments,

FIG. 39A schematically depicts a perspective view of an apparatus according to some embodiments,

FIG. 39B schematically depicts a side view of an apparatus according to some embodiments,

FIG. 39C schematically depicts a perspective view of aspects of the apparatus of FIG. 39A,

FIG. 40 schematically depicts a perspective view of an apparatus according to some embodiments,

FIG. 41 schematically depicts a perspective view of aspects of the apparatus of FIG. 40,

FIG. 42 schematically depicts a perspective view of aspects of the apparatus of FIG. 40, and

FIG. 43 schematically depicts a block diagram of a base station according to some embodiments.

### DESCRIPTION OF SOME EXEMPLARY EMBODIMENTS

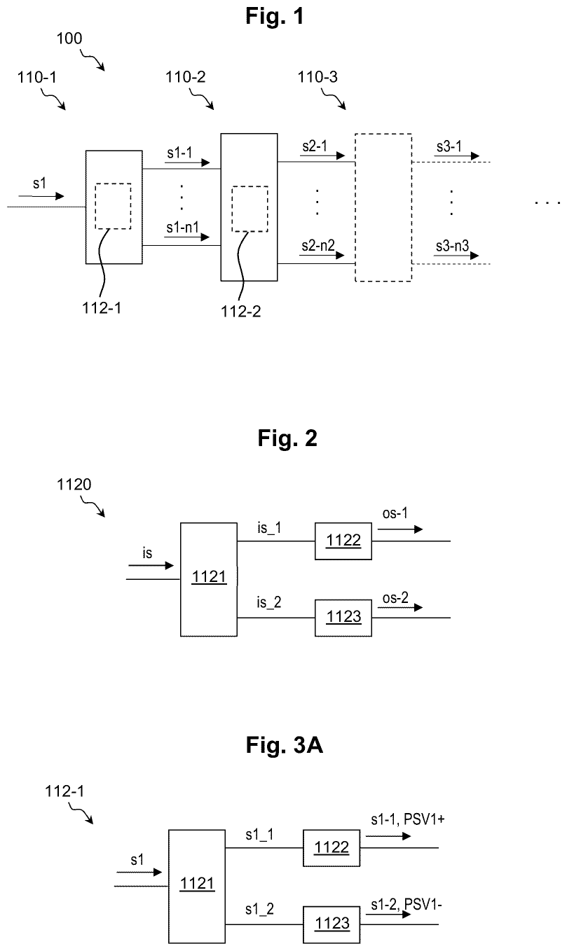

Some embodiments, see FIGS. 1 and 4, relate to an apparatus 100 for processing radio frequency signals, comprising a first phase shifting stage 110-1 configured to receive 200 (FIG. 4) an RF signal s1 and to provide 202 n1 many, with n1>=2, phase-shifted portions s1-1, s1-n1 of the RF signal s1, and at least a second phase shifting stage 110-2 configured to receive 204 the n1 many phase-shifted portions s1-1, s1-n1 of the RF signal s1 and to provide 206 n2 many, with n2>=n1, phase-shifted portions s2-1, s2-n2 of the RF signal s1 based on the received n1 many phase-shifted portions s1-1, s1-n1 of the RF signal s1, wherein a phase shift applied by the second phase shifting stage 110-2 to the n1 many phase-shifted portions s1-1, s1-n1 of the RF signal s1 is based on at least one phase shift applied by the first phase shifting stage 110-1 to the n1 many phase-shifted portions s1-1, . . . , s1-n1 of the RF signal s1 with respect to the RF signal s1.

In other words, in some embodiments, the phase shift applied by the second phase shifting stage 110-2 on its input signals s1-1, . . . , s1-n1 may depend on a phase shift applied by the first phase shifting stage 110-1 on its input signal s1. This way, in some embodiments, a parallelized phase shifting may be attained by using the phase shifting stages 110-1, 110-2, wherein individual portions of the input signal are subsequently phase shifted by the various phase shifting stages 110-1, 110-2.

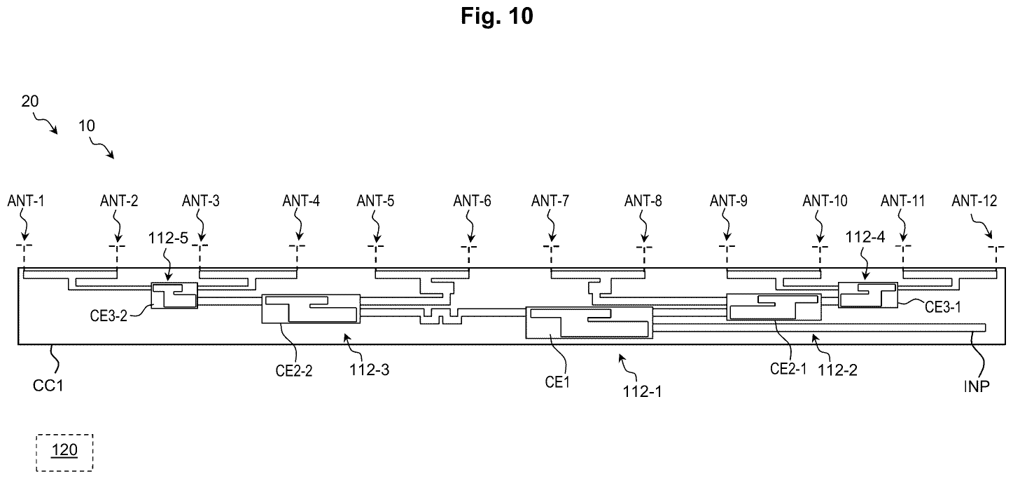

While some exemplary embodiments explained herein with reference to the drawings primarily relate to examples of receiving the RF signal s1 at the first phase shifting stage 110-1, e.g. for obtaining various phase-shifted signal portions, which, in some embodiments, may for example be provided to an antenna system or antenna array 20, see for example FIG. 10, for example for transmission via the antenna array 20, in some embodiments, and without loss of generality, radio frequency signals may also be processed by the at least two phase shifting stages 110-1, 110-2 in a reverse direction, for example receiving multiple radio frequency signals at the second phase shifting stage 110-2 and combining phase-shifted versions of the multiple radio frequency signals by means of the second phase shifting stage 110-2, for example for proving a so obtained combined signal to a further, for example the first, phase shifting stage. In other words, in some embodiments, a radio frequency signal flow may be directed from the second phase shifting stage 110-2 to the first phase shifting stage 110-1.

In other words, in some embodiments, the apparatus according to the embodiments may be reciprocal. As an example, in some embodiments, wherein the apparatus 100 may be used for an antenna array, the apparatus 100 may be used for phase shifting radio frequency signals of both a transmit direction and a receive direction, with respect to the antenna array.

In some embodiments, the apparatus 100 may comprise more than two phase shifting stages 110-1, 110-2, see for example the optional third phase shifting stage 110-3. Similar to the second phase shifting stage 110-2, in some embodiments, the third phase shifting stage 110-3 may be configured to receive the n2 many phase-shifted portions s2-1, . . . , s2-n2 of the RF signal s1 and to provide n3 many, with n3>=n1 and/or n3>=n2, phase-shifted portions s3-1, . . . , s3-n3 of the RF signal s1, based on the received n2 many phase-shifted portions s2-1, . . . , s2-n2 of the RF signal s1, wherein for example a phase shift applied by the third phase shifting stage 110-3 to the n2 many phase-shifted portions s2-1, . . . , s2-n2 of the RF signal s1 may be based on at least one phase shift applied by the first phase shifting stage 110-1 to the n1 many phase-shifted portions s1-1, . . . , s1-n1 of the RF signal s1 with respect to the RF signal s1 and/or on at least one phase shift applied by the second phase shifting stage 110-2 to at least one of the n2 many phase-shifted portions s2-1, . . . , s2-n2 of the RF signal s1.

FIG. 2 schematically depicts a simplified block diagram of a combined splitter and phase shifting module 1120 according to some embodiments. Block 1121 symbolizes a splitter configured to split an input signal is (for example the radio frequency signal s1 of FIG. 1 or any of the portions s1-1, . . . , s1-n1, s2-1, . . . , s2-n2, . . . ) into at least two signal portions is_1, is_2, for example according to a predetermined splitting ratio of for example 1:1 (e.g., the two signal portions is_1, is_2 each comprise half of the signal energy of the input signal is). Block 1122 symbolizes a first phase shifter applying a first phase shift to the first signal portion is_1, whereby a first phase shifted signal portion os-1 may be obtained. Block 1123 symbolizes a second phase shifter applying a second phase shift to the second signal portion is_2, whereby a second phase shifted signal portion os-2 may be obtained. In some embodiments, the second phase shift may be equal to the first phase shift. In some embodiments, the second phase shift may be different from the first phase shift.

In some embodiments, at least one phase shifting stage 110-1, 110-2, 110-3 of the apparatus 100 of FIG. 1 may comprise at least one configuration 1120 as exemplarily depicted by FIG. 2. In some embodiments, the first phase shifting stage 110-1 may comprise a first phase shifter module 112-1, which for example comprises one or more configurations 1120 as exemplarily depicted by FIG. 2. In some embodiments, the second phase shifting stage 110-2 may comprise a second phase shifter module 112-2, which for example comprises one or more configurations 1120 as exemplarily depicted by FIG. 2. In some embodiments, the optional third phase shifting stage 110-3 may comprise a third phase shifter module (not shown), which for example comprises one or more configurations 1120 as exemplarily depicted by FIG. 2.

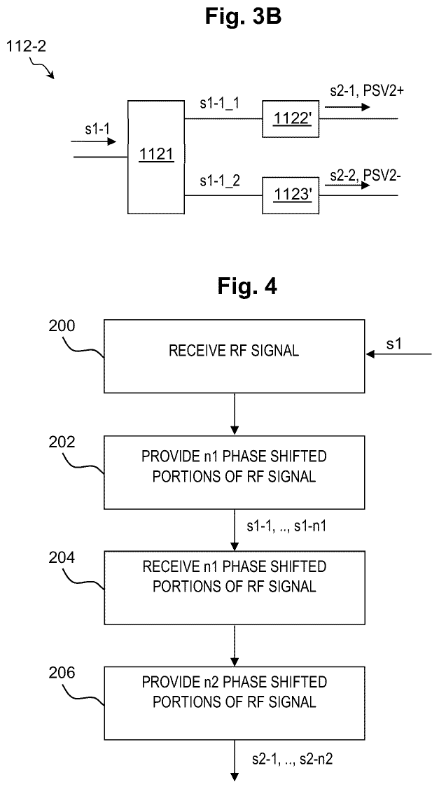

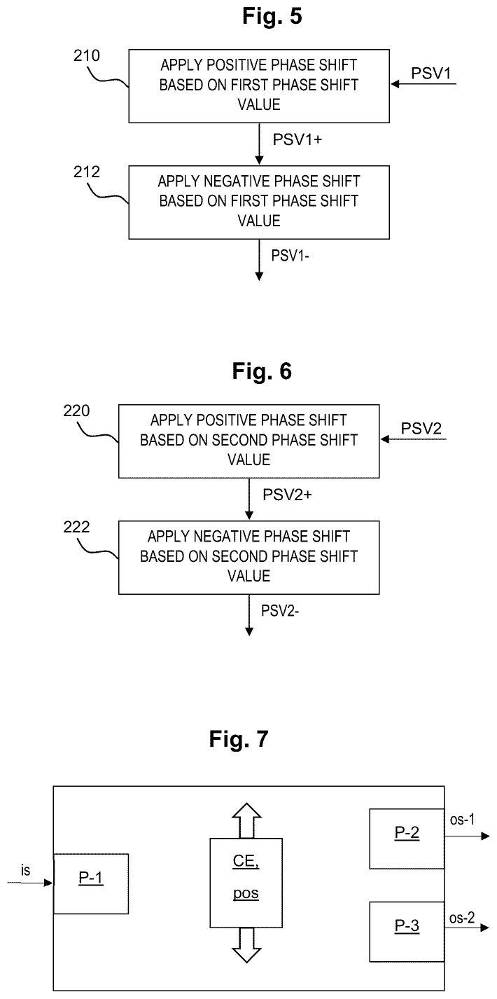

In some embodiments, FIG. 3A, 5, the first phase shifting stage 110-1 and/or the first phase shifter module 112-1 is configured to apply 210 (FIG. 5) a positive phase shift PSV1+ by a first phase shift value PSV1 to at least a first portion s1_1 of the radio signal s1 to obtain a first phase-shifted portion s1-1 of the RF signal s1 and to apply 212 (FIG. 5) a negative phase shift PSV1− by the first phase shift value PSV1 to at least a second portion s1_2 of the radio signal s1 to obtain a second phase-shifted portion s1-2 of the RF signal s1.

In some embodiments, FIG. 3B, 6, the second phase shifting stage 110-2 (FIG. 1) is configured to apply 220 a positive phase shift PSV2+ by a second phase shift value PSV2 to at least a first portion s1-1_1 of the first phase-shifted portion s1-1 of the RF signal s1 and to apply 222 a negative phase shift PSV2− by the second phase shift value PSV2 to at least a second portion s1-1_2 of the first phase-shifted portion s1-1 of the RF signal s1.

In some embodiments, the second phase shifter module 112-2 (FIG. 3B) may comprise phase shifters 1122′, 1123′ similar to the phase shifters 1122, 1123 of the first phase shifter module 112-1 of FIG. 3A.

In some embodiments, the second phase shift value PSV2 is a multiple or a fraction of the first phase shift value. In some embodiments, the second phase shift value PSV2 may e.g. equal 50 percent of the first phase shift value.

In some embodiments, the first phase shifting stage 110-1 and the second phase shifting stage 110-2 each comprises at least one phase shifter module 112-1, 112-2 configured to split an input signal into at least two phase shifted output signals, e.g. similar to the configuration 1120 of FIG. 2.

In some embodiments, FIG. 7, the phase shifter module comprises a first port P-1 for receiving the input signal is, a second port P-2 for providing a first one of the at least two output signals os-1, os-2, and a third port P-3 for providing a second one of the at least two output signals, wherein the phase shifter module further comprises at least one coupling element CE arranged movably (for example slidably) with respect to the first port P-1, the second port P-2 and the third port P-3, the at least one coupling element CE coupling the first port P-1 with the second port P-2 and the third port P-3 with a predetermined phase shift based on a relative position pos of the at least one coupling element CE with respect to the first port P-1. In some embodiments, on this basis, the phase shifted output signals s1-1, s1-2 (FIG. 3A) and/or the phase shifted output signals s2-1, s2-2 (FIG. 3B) may be obtained.

In some embodiments, the apparatus 100 (FIG. 1) is configured to move a coupling element CE (FIG. 7) of the phase shifter module 112-1 (FIG. 1) of the first phase shifting stage 110-1 and a coupling element CE of the phase shifter module 112-2 of the second phase shifting stage 110-2 at different speeds. This way, in some embodiments, different relative phase shifts may be attained in the different phase shifting stages 110-1, 110-2.

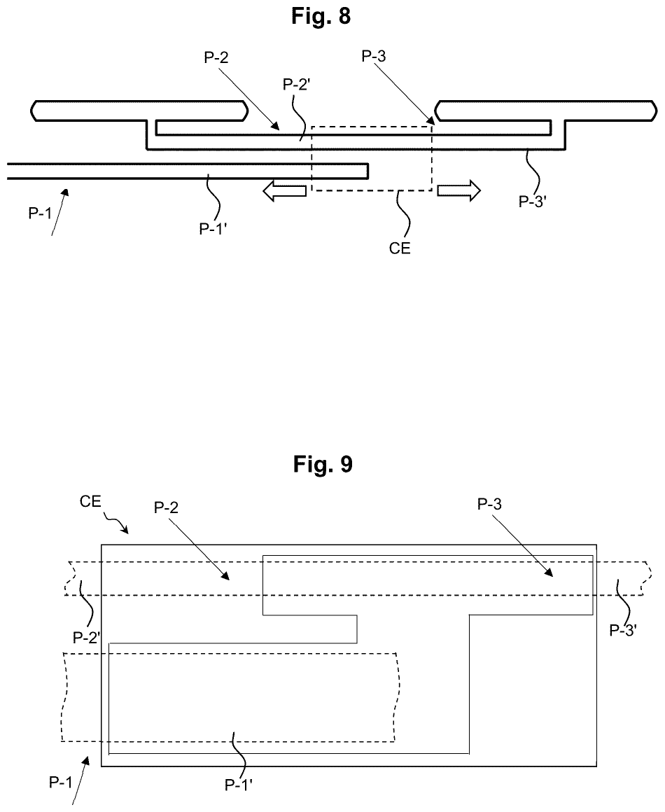

FIG. 8 schematically depicts a simplified top view of a phase shifter module according to some embodiments. In some embodiments, the phase shifter module may be implemented using a carrier such as a printed circuit board and electrically conductive elements such as stripline or microstrip segments.

In some embodiments, each one of the first port P-1 and the second port P-2 and the third port P-3 is assigned a respective transmission line segment P-1′, P-2′, P-3′, wherein the coupling element CE is configured to establish an electromagnetic, for example capacitive, coupling between the transmission line segment P-1′ associated with the first port P-1 and the transmission line segment P-2′ associated with the second port P-2 and between the transmission line segment P-1′ associated with the first port P-1 and the transmission line segment P-3′ associated with the third port P-3. In some embodiments, the transmission line segments P-1′, P-2′, P-3′ may for example be arranged on a, for example common, carrier, for example a printed circuit board, and the coupling element may be an electrically conductive element (optionally arranged on a further carrier) capacitively coupled with the transmission line segments P-1′, P-2′, P-3′ and movable relative to the transmission line segments P-1′, P-2′, P-3′. In some embodiments, the coupling element CE may slide on the transmission line segments P-1′, P-2′, P-3′ or on a carrier the transmission line segments P-1′, P-2′, P-3′ are arranged on.

FIG. 10 schematically depicts a simplified top view according to some embodiments. Reference sign 112-1 indicates a phase shifter module of a first phase shifting stage 110-1 (FIG. 1), reference signs 112-2, 112-3 of FIG. 10 indicate phase shifter modules of a second phase shifting stage 110-2 (FIG. 1), and reference signs 112-4, 112-5 indicate phase shifter modules of a third phase shifting stage 110-3 (FIG. 1). In some embodiments, the configuration of FIG. 10 may be used to implement a phase shifter 10.

The phase shifter module 112-1 of the first phase shifting stage comprises a first coupling element CE1, the phase shifter modules 112-2, 112-3 of the second phase shifting stage comprises respective second and third coupling elements CE2-1, CE2-2, and the phase shifter modules 112-4, 112-5 of the third phase shifting stage comprises respective fourth and fifth coupling elements CE3-1, CE3-2. In some embodiments, at least one, for example more than one, for example each of the coupling elements CE1, CE2-1, CE2-2, CE3-1, CE3-2 of FIG. 10 comprises a structure similar or identical to the configuration CE of FIG. 8 and/or FIG. 9.

Reference sign INP of FIG. 10 symbolizes an input port, where a radio frequency signal s1 (FIG. 1) may be provided to the apparatus of FIG. 10, for example for power splitting and phase shifting according to the embodiments.

In some embodiments, the phase shifted signal portions obtained for example at an output of the third phase shifting stage may be provided to antenna elements ANT-1, ANT-2, ANT-3, . . . , ANT-12.

As an example, in some embodiments, the antenna elements ANT-1, ANT-2 may be provided with phase shifted signal portions of the input signal s1 having a relative phase shift with respect to the input signal s1 of 70, wherein a contribution of +4ϕ phase shift may be provided for example by the first phase shifting stage 110-1 (FIG. 1), for example using the phase shifter module 112-1, wherein a contribution of +2ϕ phase shift may be provided for example by the second phase shifting stage 110-2 (FIG. 1), for example using the phase shifter module 112-3, and wherein a contribution of +1ϕ phase shift may be provided for example by the third phase shifting stage 110-3 (FIG. 1), for example using the phase shifter module 112-5. In other words, the cumulative phase shift of the signal portions of the input signal s1 provided to the antenna elements ANT-1, ANT-2 via the phase shifter modules 112-1, 112-3, 112-5 is +4ϕ +2ϕ +1ϕ=+7ϕ.

Similarly, as an example, in some embodiments, the antenna elements ANT-3, ANT-4 may be provided with phase shifted signal portions of the input signal s1 having a relative phase shift with respect to the input signal s1 of 50, wherein a contribution of +4ϕ phase shift may be provided for example by the first phase shifting stage 110-1 (FIG. 1), for example using the phase shifter module 112-1, wherein a contribution of +2ϕ phase shift may be provided for example by the second phase shifting stage 110-2 (FIG. 1), for example using the phase shifter module 112-3, and wherein a contribution of −1ϕ phase shift may be provided for example by the third phase shifting stage 110-3 (FIG. 1), for example using the phase shifter module 112-5. In other words, the cumulative phase shift of the signal portions of the input signal s1 provided to the antenna elements ANT-3, ANT-4 via the phase shifter modules 112-1, 112-3, 112-5 is +4ϕ +2ϕ −1ϕ=+5ϕ.

Similarly, as an example, in some embodiments, the antenna elements ANT-5, ANT-6 may be provided with phase shifted signal portions of the input signal s1 having a relative phase shift with respect to the input signal s1 of 20, wherein a contribution of +4ϕ phase shift may be provided for example by the first phase shifting stage 110-1 (FIG. 1), for example using the phase shifter module 112-1, wherein a contribution of −2ϕ phase shift may be provided for example by the second phase shifting stage 110-2 (FIG. 1), for example using the phase shifter module 112-3. In other words, the cumulative phase shift of the signal portions of the input signal s1 provided to the antenna elements ANT-5, ANT-6 via the phase shifter modules 112-1, 112-3, is +4ϕ −2ϕ=+2ϕ.

Similarly, as an example, in some embodiments, the antenna elements ANT-7, ANT-8 may be provided with phase shifted signal portions of the input signal s1 having a relative phase shift with respect to the input signal s1 of −2ϕ, wherein a contribution of −4ϕ phase shift may be provided for example by the first phase shifting stage 110-1 (FIG. 1), for example using the phase shifter module 112-1, wherein a contribution of +2ϕ phase shift may be provided for example by the second phase shifting stage 110-2 (FIG. 1), for example using the phase shifter module 112-2. In other words, the cumulative phase shift of the signal portions of the input signal s1 provided to the antenna elements ANT-7, ANT-8 via the phase shifter modules 112-1, 112-2 is +4ϕ −2ϕ=+2ϕ.

Similarly, as an example, in some embodiments, the antenna elements ANT-9, ANT-10 may be provided with phase shifted signal portions of the input signal s1 having a relative phase shift with respect to the input signal s1 of −5ϕ, wherein a contribution of −4ϕ phase shift may be provided for example by the first phase shifting stage 110-1 (FIG. 1), for example using the phase shifter module 112-1, wherein a contribution of −2ϕ phase shift may be provided for example by the second phase shifting stage 110-2 (FIG. 1), for example using the phase shifter module 112-2, and wherein a contribution of +1ϕ phase shift may be provided for example by the third phase shifting stage 110-3 (FIG. 1), for example using the phase shifter module 112-4. In other words, the cumulative phase shift of the signal portions of the input signal s1 provided to the antenna elements ANT-9, ANT-10 via the phase shifter modules 112-1, 112-2, 112-4 is −4ϕ −2ϕ+1ϕ=−50.

Similarly, as an example, in some embodiments, the antenna elements ANT-11, ANT-12 may be provided with phase shifted signal portions of the input signal s1 having a relative phase shift with respect to the input signal s1 of −7ϕ, wherein a contribution of −4ϕ phase shift may be provided for example by the first phase shifting stage 110-1 (FIG. 1), for example using the phase shifter module 112-1, wherein a contribution of −2ϕ phase shift may be provided for example by the second phase shifting stage 110-2 (FIG. 1), for example using the phase shifter module 112-2, and wherein a contribution of −1ϕ phase shift may be provided for example by the third phase shifting stage 110-3 (FIG. 1), for example using the phase shifter module 112-4. In other words, the cumulative phase shift of the signal portions of the input signal s1 provided to the antenna elements ANT-11, ANT-12 via the phase shifter modules 112-1, 112-2, 112-4 is −4ϕ −2ϕ −1ϕ=−7ϕ.

In some embodiments, the apparatus according to the embodiments may be used to provide a phased array antenna system, wherein different antenna elements ANT-1, ANT-2, . . . , ANT-12 are provided with different signal portions of the input signal s1 having different relative phase shifts as may for example be obtained using the principle according to the embodiments.

Providing the respective phase shifting stages 110-1, 110-2, 110-3 or their components on a common carrier such as a printed circuit board may enable to avoid radio frequency cable connections between the various components thus reducing complexity and cost.

In some embodiments, the configuration of FIG. 10, for example the phase shifter 10, may be provided for implementing an antenna array 20, for example a phased array, for example comprising the antenna elements ANT-1, ANT-2, . . . , ANT-12.

In some embodiments, the phase shifter 10 and/or the antenna array 20 may be used for receiving radio frequency signals or for transmitting radio frequency signals, or for both receiving and transmitting (“transceiving”) radio frequency signals.

As an example, in a transmitting scenario according to some embodiments, the port INP may be an input port for receiving a radio frequency signal, and a signal flow may be directed from the port INP to the antenna elements ANT-1, ANT-2, . . . , ANT-12.

However, in some embodiments, in a receiving scenario, the port INP may be used as an output port for providing a radio frequency signal from the phase shifter 10, and a signal flow may be directed from the antenna elements ANT-1, ANT-2, . . . , ANT-12 to the (output) port INP. In some embodiments, the antenna array 20 may at least temporarily be used for transmitting radio frequency signals and/or for receiving radio frequency signals.

In some embodiments, components 112-1, 112-2, . . . , 112-5 of all three phase shifting stages 110-1, 110-2, 110-3, for example with exception of the coupling elements CE1, CE2-1, CE2-2, CE3-1, CE3-2, may be provided on a common carrier CC1, for example on a common printed circuit board CC1, whereas the coupling elements CE1, CE2-1, CE2-2, CE3-1, CE3-2 may be provided movably relative for example to the ports P-1, P-2, P-3 (FIG. 9) of the respective phase shifter module. In some embodiments, at least some, or all, coupling elements of a same phase shifting stage may be provided on a common carrier, for example a common printed circuit board.

In some embodiments, the coupling elements CE1, CE2-1, CE2-2, CE3-1, CE3-2 may be slidably arranged close to the common carrier CC1 to enable for example capacitive coupling between the different transmission line segments P-1′, P-2′, P-3′ and the respective coupling element CE (FIG. 9).

In some embodiments, displacing the coupling element CE (FIG. 9) by a first distance from a reference position may for example cause a corresponding phase shift for an input signal provided at the first transmission line segment P-1′ which is coupled to the second transmission line segment P-2′ and a corresponding phase shift for the input signal provided at the first transmission line segment P-1′ which is coupled to the third transmission line segment P-3′. This way, in some embodiments, displacing the coupling element CE may effect a respective phase shift to signal portions processed by the exemplary structure according to FIG. 7, 9.

In some embodiments, the apparatus 100 (FIG. 1) is configured to move coupling elements CE1 (FIG. 10) of the phase shifter module of the first phase shifting stage with a same relative speed with respect to coupling elements CE2-1, CE2-2 of phase shifter modules 112-2, 112-3 of the second phase shifting stage. This enables to impact or attain a same relative phase shift associated with the phase shifter modules 112-2, 112-3 of the second phase shifting stage with respect to the first phase shifting stage.

In some embodiments, the apparatus 100 (FIG. 1) is configured to move coupling elements CE2-1, CE2-2 (FIG. 10) of the phase shifter module of the second phase shifting stage with a same relative speed with respect to coupling elements CE3-1, CE3-2 of phase shifter modules 112-4, 112-5 of the third phase shifting stage. This enables to effect a same relative phase shift associated with the phase shifter modules 112-4, 112-5 of the third phase shifting stage with respect to the second phase shifting stage.

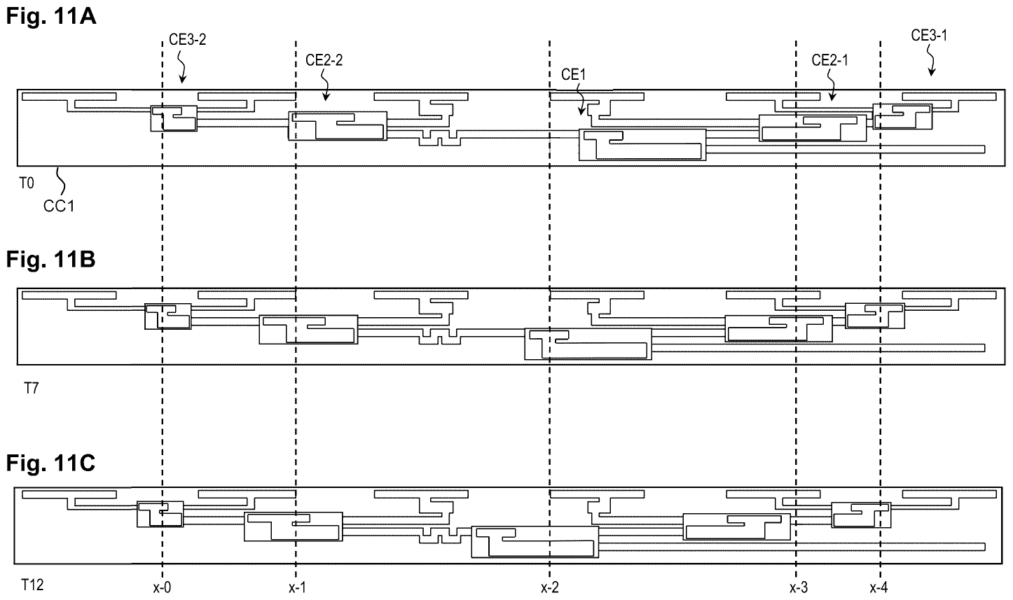

FIG. 11A schematically depicts a simplified top view of an apparatus according to some embodiments in a first operational state, wherein the coupling elements CE1, CE2-1, CE2-2, CE3-1, CE3-2 are arranged in respective first positions with respect to the common carrier CC1. As an example, when using the apparatus according to FIG. 11A to provide different phased input signals to different antenna elements (see for example FIG. 10), the respective first positions of the coupling elements CE1, CE2-1, CE2-2, CE3-1, CE3-2 may correspond with a first antenna characteristic (for example “T0”) of the antenna system comprising the different antenna elements.

FIG. 11B schematically depicts a simplified top view of the apparatus of FIG. 11A in a second operational state, wherein the coupling elements CE1, CE2-1, CE2-2, CE3-1, CE3-2 are arranged in respective second positions with respect to the common carrier CC1. As an example, when using the apparatus according to FIG. 11A, 11B to provide different phased input signals to different antenna elements (see for example FIG. 10), the respective second positions of the coupling elements CE1, CE2-1, CE2-2, CE3-1, CE3-2 (FIG. 11B) may correspond with a second antenna characteristic (for example “T7”) of the antenna system comprising the different antenna elements.

FIG. 11C schematically depicts a simplified top view of the apparatus of FIG. 11A in a third operational state, wherein the coupling elements CE1, CE2-1, CE2-2, CE3-1, CE3-2 are arranged in respective third positions with respect to the common carrier CC1. As an example, when using the apparatus according to FIG. 11A, 11B, 11C to provide different phased input signals to different antenna elements (see for example FIG. 10), the respective third positions of the coupling elements CE1, CE2-1, CE2-2, CE3-1, CE3-2 (FIG. 11B) may correspond with a third antenna characteristic (for example “T12”) of the antenna system comprising the different antenna elements.

In some embodiments, FIG. 10, the apparatus comprises a drive system 120 for driving a movement of one or more of the coupling elements CE, CE1, CE2-1, CE2-2, CE3-1, CE3-2.

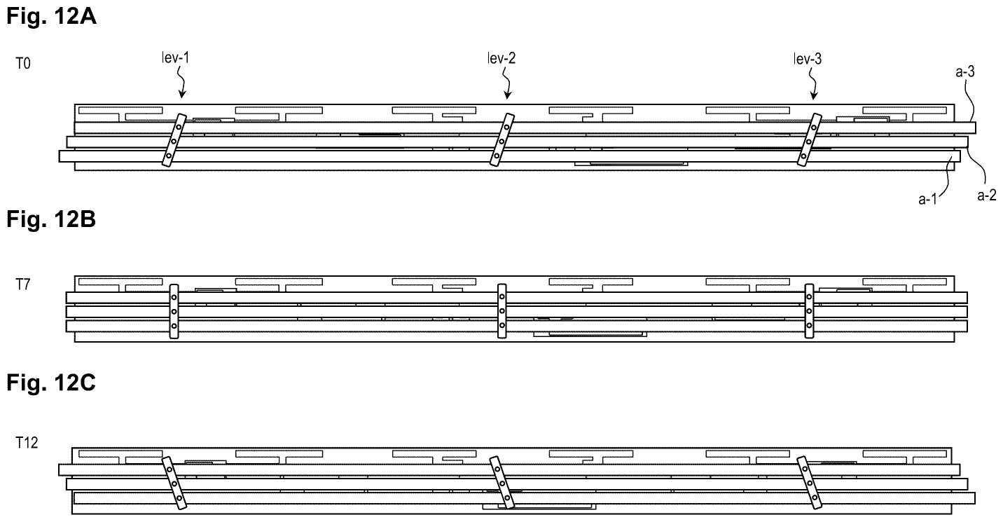

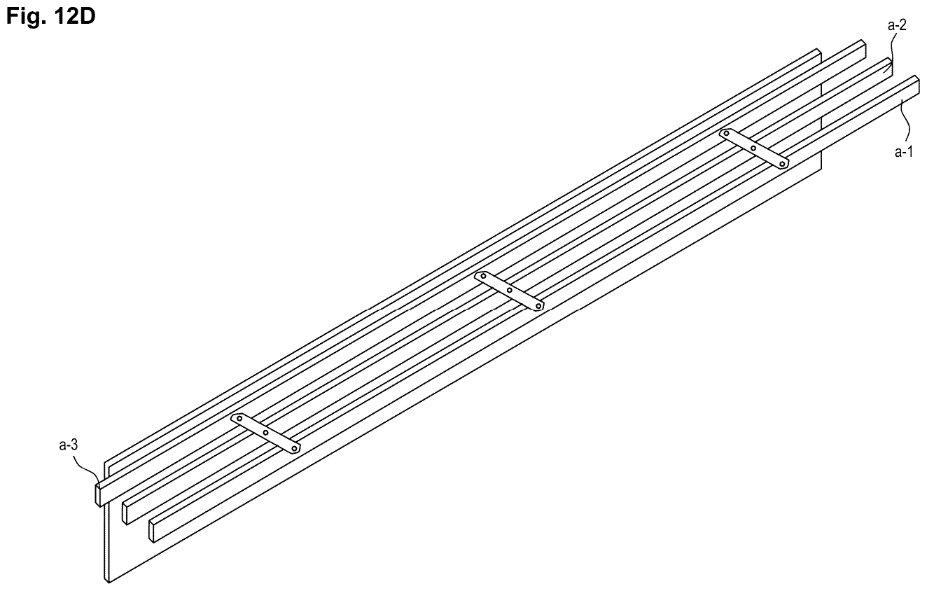

In some embodiments, FIG. 12A, 12B, 12C, the drive system 120 comprises a lever-arm system having a plurality of arms a-1, a-2, a-3, wherein each arm a-1, a-2, a-3 is coupled to one or more coupling elements of a same phase shifting stage, and wherein the arms a-1, a-2, a-3 are rotatably connected to at least one lever lev-1, lev-2, lev-3.

In some embodiments, the apparatus is configured to move a) the at least one lever lev-1, lev-2, lev-3 and/or b) at least one of the plurality of arms a-1, a-2, a-3 to drive a movement of the plurality of arms a-1, a-2, a-3.

In some embodiments, for example the coupling element CE1 of the first phase shifting stage 110-1 of the configuration of FIG. 10 may be coupled with, for example arranged on, the first arm a-1.

In some embodiments, for example the coupling elements CE2-1, CE2-2 of the second phase shifting stage 110-2 of the configuration of FIG. 10 may be coupled with, for example arranged on, the second arm a-2.

In some embodiments, for example the coupling elements CE3-1, CE3-2 of the third phase shifting stage 110-3 of the configuration of FIG. 10 may be coupled with, for example arranged on, the third arm a-3.

FIG. 12A depicts the lever-arm system in a first state, FIG. 12B depicts the lever-arm system in a second state, and FIG. 12C depicts the lever-arm system in a third state. FIG. 12D schematically depicts a perspective view of the lever-arm system of FIG. 12A.

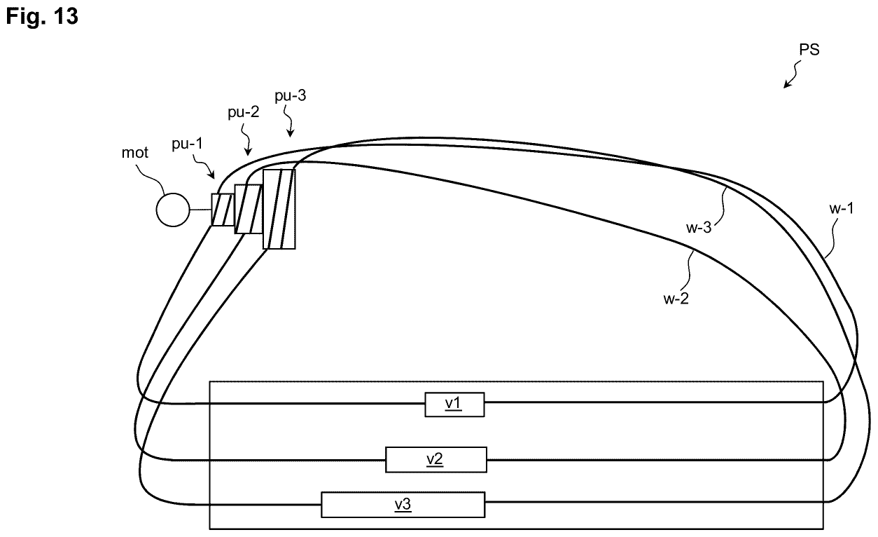

In some embodiments, FIG. 13, the drive system comprises a pulley system PS having a plurality of pulleys pu-1, pu-2, pu-3, wherein each pulley pu-1, pu-2, pu-3 is coupled to one or more coupling elements of a same phase shifting stage, and wherein the apparatus is configured to drive different pulleys pu-1, pu-2, pu-3 at a respective different speed v1, v2, v3.

In some embodiments, at least one pulley pu-1, pu-2, pu-3 of the plurality of pulleys comprises a wire w-1, w-2, w-3 for driving a movement of one or more coupling elements of a same phase shifting stage.

In some embodiments, at least one of the wires w-1, w-2, w-3 comprises at least one of the following materials, and not limited to: plastic, nylon, polyamide, polypropylene, Kevlar, etc.

In some embodiments, the first pulley pu-1 may be used to drive the coupling element CE1 of the first phase shifting stage 110-1 of the exemplary configuration of FIG. 10. In some embodiments, the second pulley pu-2 may be used to drive the coupling elements CE2-1, CE2-2 of the second phase shifting stage 110-2 of the exemplary configuration of FIG. 10. In some embodiments, the third pulley pu-3 may be used to drive the coupling elements CE3-1, CE3-2 of the third phase shifting stage 110-3 of the exemplary configuration of FIG. 10.

In some embodiments, a motor mot may be used to drive the pulleys pu-1, pu-2, pu-3.

FIG. 14 schematically depicts a perspective view of an exemplary pulley system according to some embodiments, wherein a first wire w-1 is used to drive a translatory movement ml of a first coupling element, for example with respect to a common carrier CC1 (FIG. 10), which may e.g. be arranged in a housing H.

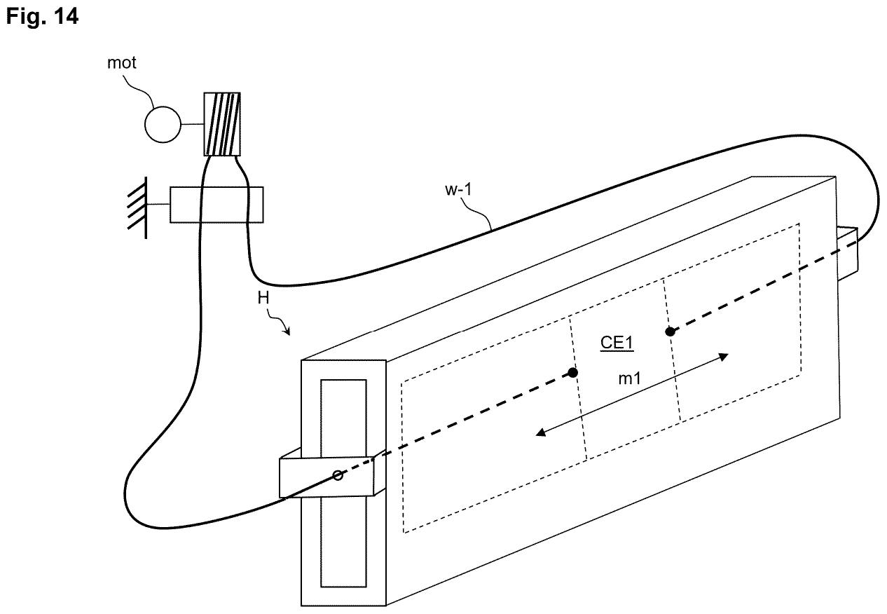

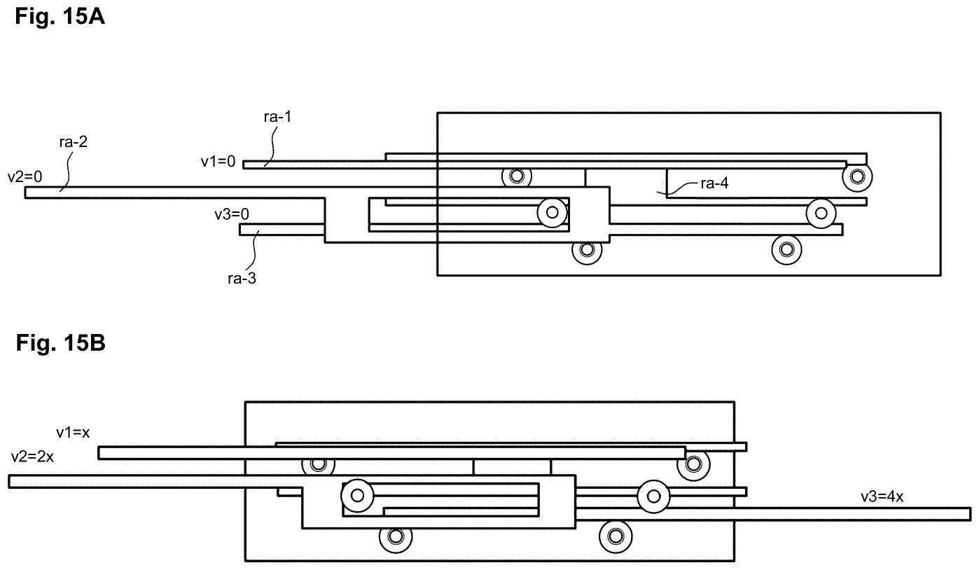

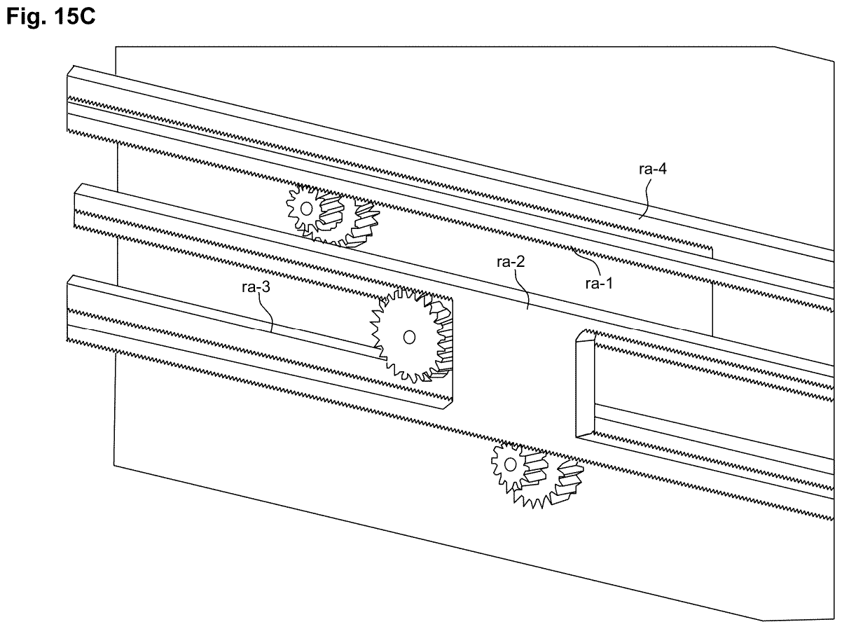

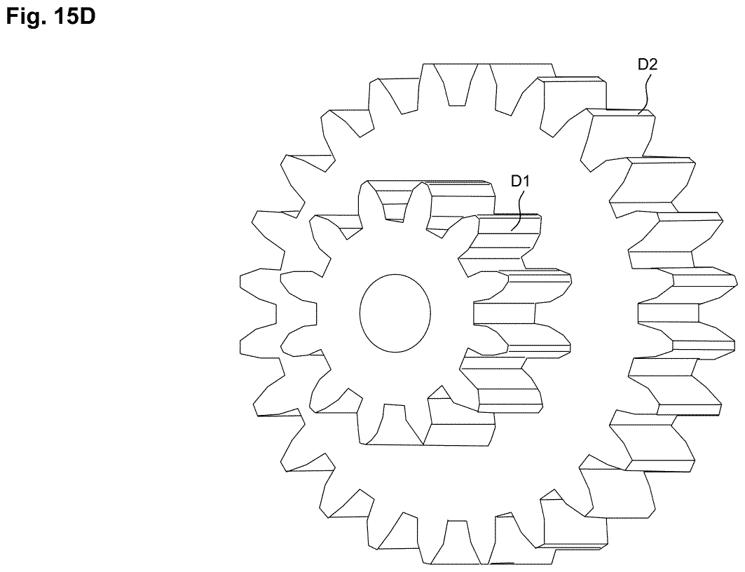

In some embodiments, FIG. 15A, 15B, 15C, the drive system 120 (FIG. 10) comprises a rack and pinion system having a plurality of racks ra-1, ra-2, ra-3, wherein each rack ra-1, ra-2, ra-3 is coupled to one or more coupling elements of a same phase shifting stage, wherein the apparatus is configured to drive different racks ra-1, ra-2, ra-3 at a respective different speed.

In the example of FIG. 15A, none of the racks ra-1, ra-2, ra-3 is moved, so that each rack ra-1, ra-2, ra-3 comprises its respective initial position V1=0 (rack ra-1), V2=0 (rack ra-2), V3=0 (rack ra-3).

In the example of FIG. 15B, the first rack ra-1 has been moved by the distance V1=x with respect to its initial position of FIG. 15A. Due to the coupling between the racks ra-1, ra-2, ra-3 with different movement ratios, the second rack ra-2 has been moved by the distance V2=2x with respect to its initial position of FIG. 15A, and the third rack ra-3 has been moved by the distance V3=4x with respect to its initial position of FIG. 15A.

FIG. 15C schematically depicts a perspective view of aspects of the rack and pinion system of FIG. 15A, 15B, and FIG. 15D schematically depicts an exemplary gearwheel having two different toothed sections with different diameters D1, D2 which may be used for coupling different racks of the configuration of FIG. 15A, 15B.

In some embodiments, the second rack ra-2 may be used as an “input”, for example for driving a movement of all racks, and the outputs may be the racks ra-1, ra-3, ra-4, wherein the rack ra-4 may be used as a transmission element for transmitting motion for example from the input rack ra-2 to the rack ra-1. In some embodiments, the input rack ra-2 may be strategically located “on the middle”, which for example permits to reach a compromise between displacement and torque required for driving the different racks ra-1, ra-2, ra-3, ra-4. In some embodiments, if a relative speed is needed to be adjusted between the different racks ra-1, ra-2, then a ratio between both diameters D1, D2 of a respective coupling gearwheel between the different racks ra-1, ra-2 may be changed.

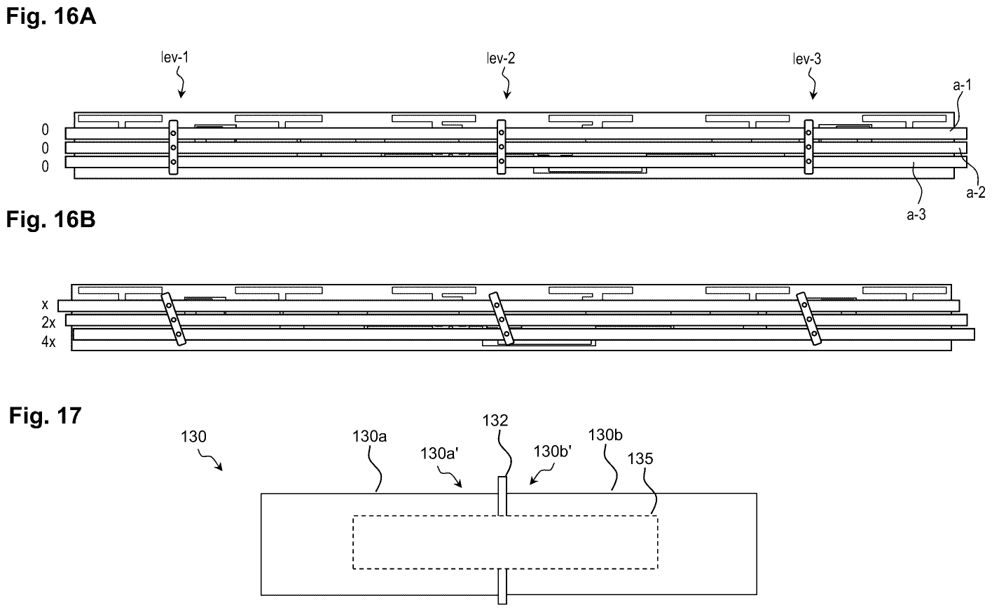

FIG. 16A, 16B schematically depict top views of an apparatus comprising a lever-arm system for driving various coupling elements of the different phase shifting stages 110-1, 110-2, 110-3 (FIG. 1), for example similar to FIG. 12A to 12D, wherein FIG. 16A depicts an initial position with all three levers lev-1, lev-2, lev-3 aligned vertically in FIG. 16A, effecting a relative displacement of “0” for each arm a-1, a-2, a-3. By contrast, FIG. 16B exemplarily depicts a different state with the levers lev-1, lev-2, lev-3 displaced angularly with respect from their vertical position of FIG. 16A, which effects a translational displacement of the first arm a-1 (horizontal in FIG. 16B) by an amount of “x” and a displacement of the second arm a-2 of “2x” and a displacement of the third arm a-3 of “4x”, whereby a predetermined relative phase shift applied in the different phase shifting stages 110-1, 110-2, 110-3 (FIG. 1) each associated with a respective arm a-1, a-2, a-3 may be attained in some embodiments.

In some embodiments, FIG. 17, the apparatus further comprises an enclosure 130, wherein the enclosure 130 comprises at least a first part 130a and a second part 130b, wherein the first part 130a is connected to the second part 130b via a connecting element 132 configured to provide a capacitive coupling between the first part 130a and the second part 130b, for example in respective axial end sections 130a′, 130b′ of the parts 130a, 130b.

In some embodiments, one or more carriers 135 for components, for example for the phase shifting stages 110-1, 110-2, 110-3 (FIG. 1), may be provided, which may for example be arranged within the enclosure 130.

FIG. 18 schematically depicts a simplified partial cross-sectional side view of aspects of an apparatus according to some embodiments. Depicted is the first part 130a of the enclosure 130 (FIG. 17). In some embodiments, the enclosure or the first part 130a, respectively (as well as a second part 130b, FIG. 17), may comprise two or more compartments or cavities 131-1, 131-2, wherein a first compartment 131-1 may comprise components for processing radio frequency signals associated with a first polarization, and wherein a second compartment 131-2 may comprise components for processing radio frequency signals associated with a second polarization, which is different from the first polarization.

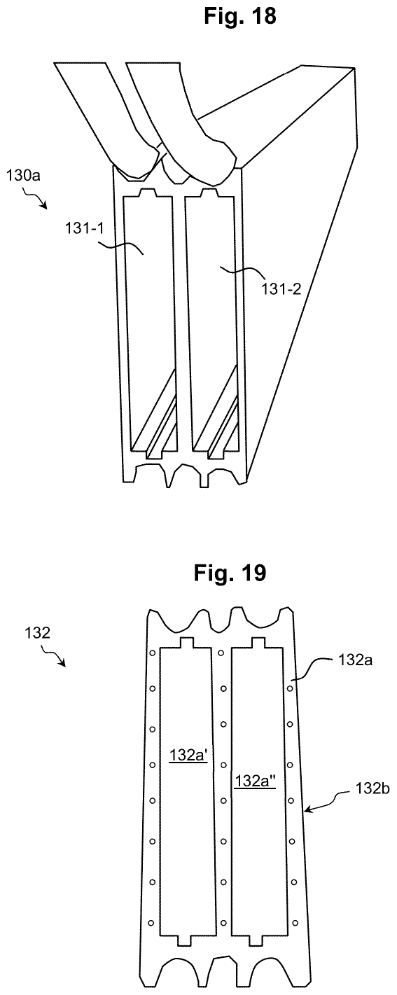

FIG. 19 schematically depicts a simplified top view of a connecting element according to some embodiments. In some embodiments, the connecting element 132 comprises a printed circuit board 132a having a plurality of electrically conductive vias 132b.

In some embodiments, the printed circuit board 132a comprises at least one opening, presently for example two openings 132a′, 132a″, each of the openings 132a′, 132a″ corresponding with one of the compartments 131-1, 131-2 (FIG. 18).

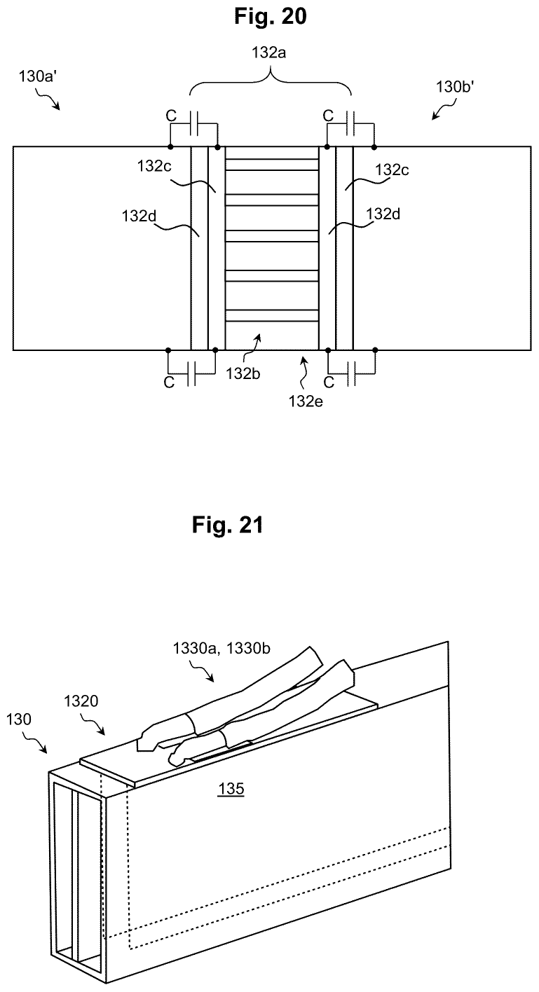

FIG. 20 schematically depicts a simplified partial cross-sectional side view of a connecting element 132 according to some embodiments. The connecting element 132 comprises a printed circuit board 132a having a plurality of electrically conductive vias 132b, at least one electrically conductive layer 132c connected to the plurality of electrically conductive vias 132b, and at least one electrically insulating layer 132d arranged on the at least one electrically conductive layer 132c.

In the present example of FIG. 20, the printed circuit board 132a comprises an electrically isolating core layer 132e, in which the plurality of vias 132b are embedded, the core layer 132e sandwiched between two electrically conductive layers 132c, wherein each of the electrically conductive layers 132c is covered by a respective electrically insulating layer 132d configured to mechanically contact front faces of the axial end sections 130a′, 130b′ of the two enclosure parts 130a, 130b.

The electrically insulating layers 132d enable to avoid direct metal-to-metal contact between the two enclosure parts 130a, 130b which in some embodiments may help to avoid passive intermodulation, PIM. However, a, for example capacitive, transfer of radio frequency energy is enabled between the enclosure parts 130a, 130b and their compartments due to the coupling capacities C.

In some embodiments, the connecting element 132 may also be used for connecting two waveguides for radio frequency applications with each other.

FIG. 21 schematically depicts a simplified perspective view of a connecting element 1320 according to some embodiments. While the connecting element 132 explained above with reference to FIGS. 17 to 20 enables to connect opposing front faces of respective axial end sections 130a′, 130b′ of two enclosure parts 130a, 130b of an enclosure 130 (FIG. 17) of the apparatus, the connecting element 1320 in some embodiments enables to connect one or more cables, e.g. coaxial cables, 1330a, 1330b to the enclosure, e.g. without soldering any component of the cables 1330a, 1330b to the enclosure 130.

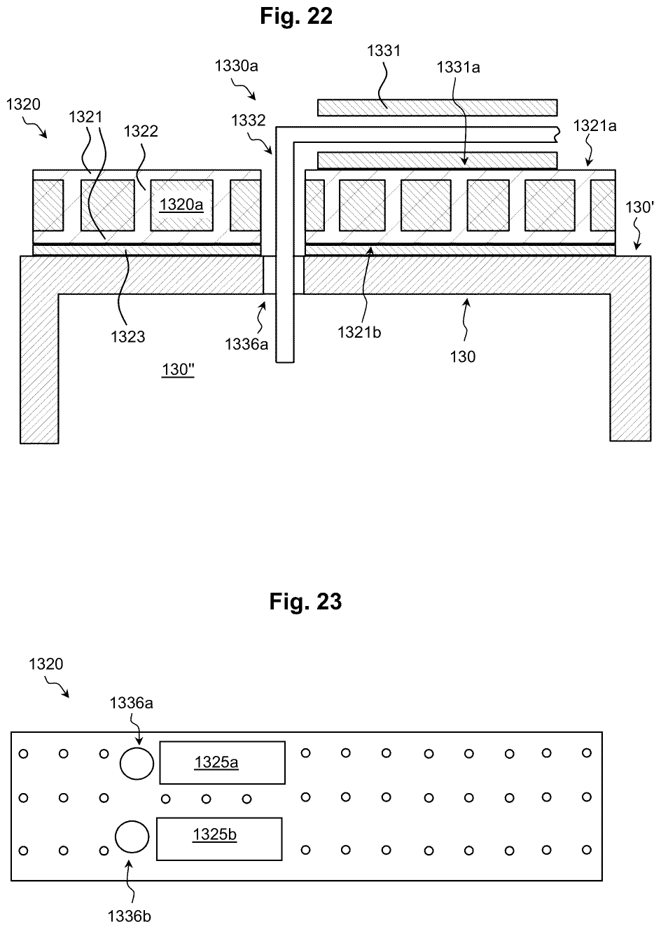

FIG. 22 schematically depicts a simplified partial cross-sectional side view of a connecting element 1320 according to some embodiments. In some embodiments, the connecting element 1320 may comprise or may be a printed circuit board 1320a, comprising two electrically conductive layers 1321, for example copper layers, with electrically conductive vias 1322 connecting the two electrically conductive layers 1321 with each other. In some embodiments, one of the electrically conductive layers 1321 may be covered with an electrically insulating layer 1323, which may e.g. contact an outer surface 130′ of the enclosure 130.

An outer or shielding conductor 1331 of the coaxial cable 1330a may be soldered 1331a to one of the conductive layers 1321 of the connecting element 1320, while an inner conductor 1332 of the coaxial cable 1330a may be guided through an opening 1336a in the connecting element 1320, and in addition through an opening in the enclosure 130, into an interior 130″ of the enclosure 130.

In some embodiments, an energy transfer goes from the upper copper layer 1321a to the lower copper layer 1321b through the vias 1322, and then, may be transferred to the enclosure 130 via a capacitive mode through the insulating film 1323.

FIG. 23 schematically depicts a simplified top view of a connecting element 1320 according to some embodiments. The connecting element 1320 comprises two soldering regions 1325a, 1325b for soldering a component, for example shielding conductor 1331 of a coaxial cable 1330a, 1330b to the connecting element 1320. The connecting element 1320 further comprises two openings 1336a, 1336b for guiding conductors of the coaxial cables 1330a, 1330b, as exemplarily disclosed above with respect to FIG. 22.

Using the connecting element 1320 in some embodiments enables to avoid a direct soldering of any component of the coaxial cables 1330a, 1330b to the enclosure 130. This way, in some embodiments, there is no requirement to provide the enclosure 130 with a tin plating.

FIG. 24 schematically depicts a simplified perspective view of the connecting element 1320 with coaxial cables 1330a, 1330b attached to an enclosure according to some embodiments.

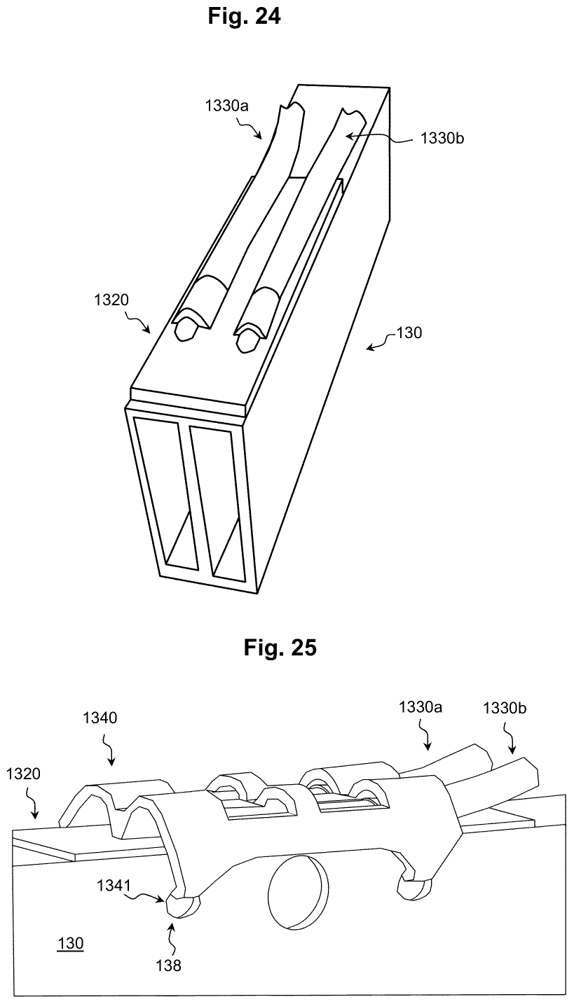

FIG. 25 schematically depicts a simplified perspective view of a connecting element 1320 with cables 1330a, 1330b attached according to some embodiments. As can be seen, a holding device 1340 may be provided which presses the connecting element 1320 together with the attached cables 1330a, 1330b against the enclosure 130. The holding device 1340 may be fixed to the enclosure 130 using form closure, e.g. hooks 1341 engaging openings 138 of the enclosure 130.

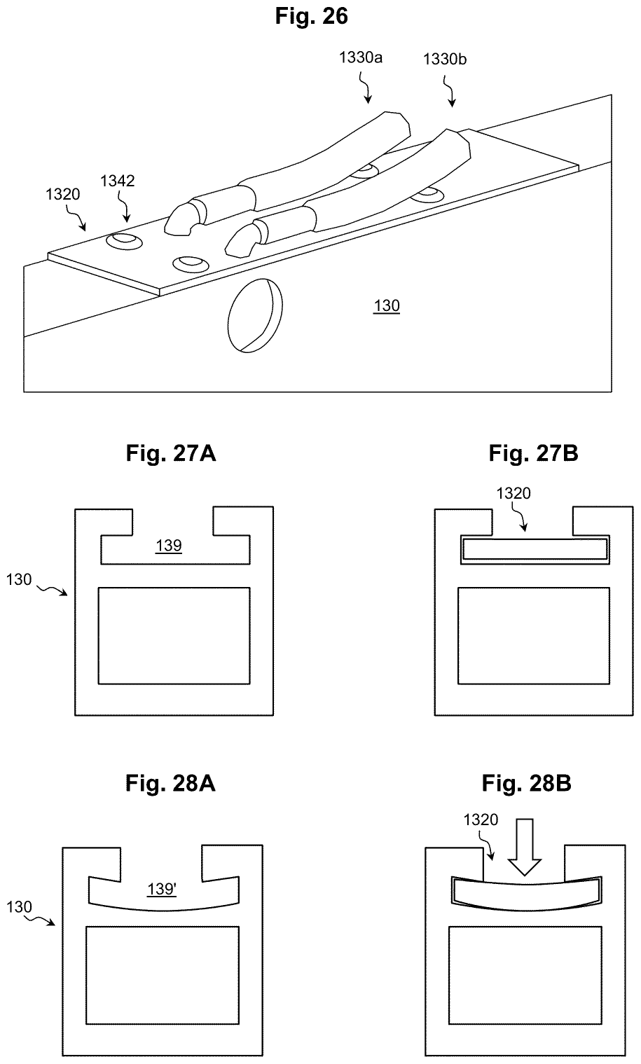

In some embodiments, FIG. 26, rivets 1342 or screws may be used to attach the connecting element 1320 to the enclosure 130.

In some embodiments (not shown), the connecting element 1320 may be glued to the enclosure 130.

In some embodiments, FIG. 27A, 27B, the enclosure 130 may comprise a slot 139 for receiving and/or retaining the connecting element 1320.

In some embodiments, FIG. 28A, 28B, the slot 139′ may comprise a curved cross-section, and the dimensions of the connecting element 1320 may be adapted to the shape of the slot 139′, which ensures a good mechanical contact between the connecting element 1320 and the enclosure. In some embodiments, the connecting element 1320 may flex at least to some extent, thus enabling a tight surface contact between its surface facing the enclosure 130 and the corresponding surface of the enclosure 130, for example touching the enclosure 130 at a position where an energy transfer mode is important, i.e. at center of the contact area.

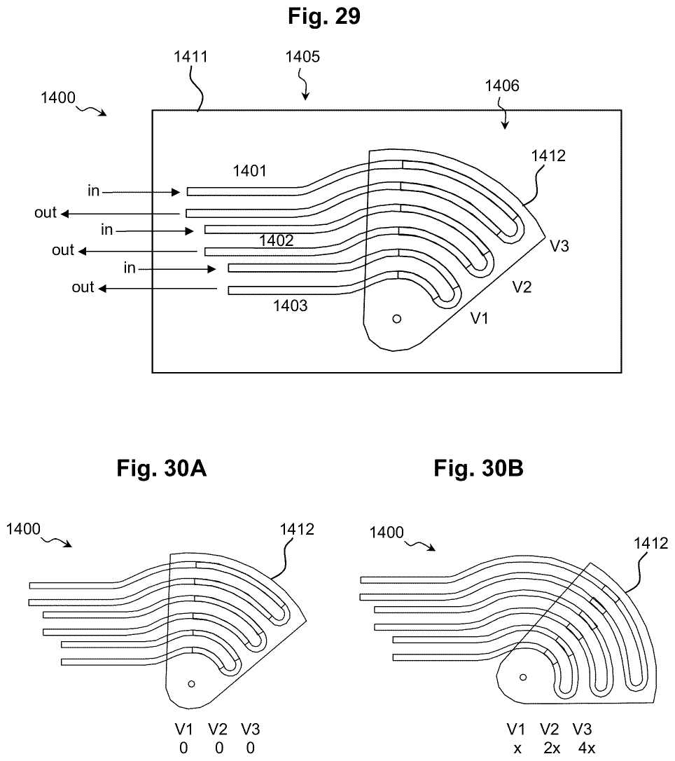

FIG. 29 schematically depicts a top view of a phase shifter arrangement 1400 according to some embodiments. Three transmission lines 1401, 1402, 1403 are provided, each of the transmission lines 1401, 1402, 1403 having a first end, for example an input, “IN”, and a second end, for example an output, “OUT”. First sections 1405 of each transmission line 1401, 1402, 1403 are provided on a first carrier 1411, for example a first printed circuit board, and second sections 1406 of each transmission line 1401, 1402, 1403 are provided on a second carrier 1412, for example a second printed circuit board, wherein the second carrier 1412 is rotatable relative to the first carrier 1411.

In some embodiments, a capacitive coupling between the second sections 1406 and the first sections 1405 may be provided. In some embodiments, a galvanic contact between the second sections 1406 and the first sections 1405 may be provided.

In some embodiments, when rotating the second carrier 1412 relative to the first carrier 1411, the length of the respective transmissions lines 1401, 1402, 1403 between the respective input “IN” and output “OUT” increases or decreases, depending on the direction and extent of rotation, see for example FIG. 30A, which schematically depicts the phase shifter arrangement 1400 of FIG. 29 in a first state, and FIG. 30B, which schematically depicts the phase shifter arrangement 1400 of FIG. 29 in a second state. It can be seen that due to the at least partial radial arrangement of the different transmission lines 1401, 1402, 1402, a length change depending on the degree of rotation of the second carrier 1412 may be different for the three transmission lines 1401, 1402, 1402. As an example, the transmission line 1401 having radially outer position for example compared with the transmission lines 1402, 1403 may experience an increased length change, as compared to the radially inner transmission lines 1402, 1403. Similar observations apply to the transmission lines 1402, 1403.

In some embodiments, one or more configurations 1400 of the type exemplarily depicted by FIG. 29, 30A, 30B may be used within at least one phase shifting stage 110-1, 110-2, 110-3 of the apparatus 100 according to FIG. 1. In some embodiments, more than one configuration 1400 may also be connected in series with each other, e.g. to effect increased overall electrical line lengths and thus also increased phase shifts.

In some embodiments, the apparatus further comprises at least two printed circuit boards 140a, 140b, see for example FIG. 32, which are mechanically connectable and/or connected to each other using form closure. In this regard,

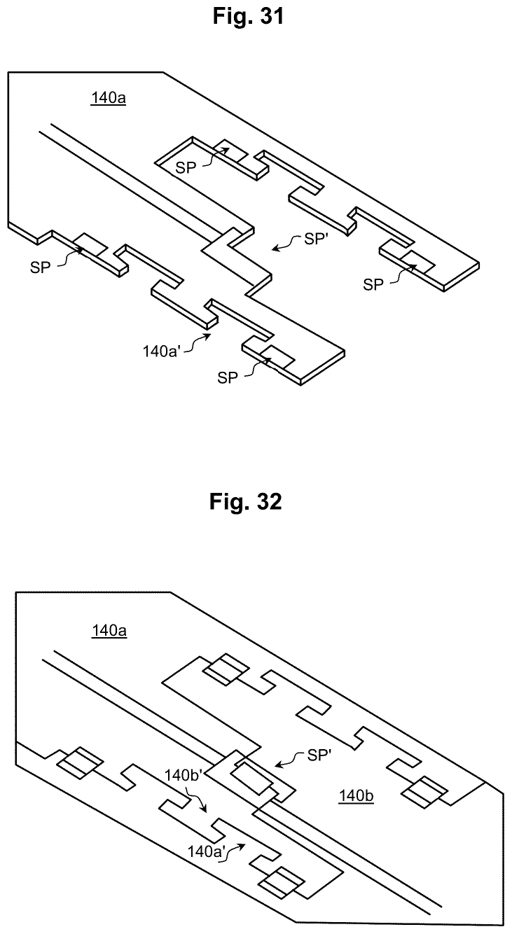

FIG. 31 schematically depicts the first printed circuit board 140a according to some embodiments, which comprises a puzzle-type (or meander-type, not shown) contour 140a′ to effect the form closure with a complementary contour 140b′ of the second printed circuit board 140b (FIG. 32).

The form closure based on the puzzle-type or meander-type contours enables in some embodiments a comparatively large surface contact area of the involved printed circuit boards 140a, 140b, which in some embodiments may enable an improved “mechanical constraint transfer” (e.g., transfer of forces and/or torque and the like) between the printed circuit boards 140a, 140b.

In some embodiments, the printed circuit boards 140a, 140b may also comprise one or more contacting pads, for example soldering pads SP, SP′, in the region of the contours 140a′, 140b′. This way, the mechanical connection of the printed circuit boards 140a, 140b may be further improved, for example by soldering joints at the soldering pads SP, SP′.

In some embodiments, at least some of the soldering pads SP′ may be used for transmission of radio frequency signals between the printed circuit boards 140a, 140b.

In some embodiments, alternatively or additionally to the soldering joints at the soldering pads SP, SP′, mechanical connecting means such as clamps, clips, hooks, and the like may be used to connect the printed circuit boards 140a, 140b.

In some embodiments, two or more printed circuit boards 140a, 140b may be connected using the form closure and the aspects exemplarily disclosed above with respect to FIG. 31, 32, which enables to provide a large printed circuit board assembly thus for example reducing a number of radio frequency cables for the apparatus 100.

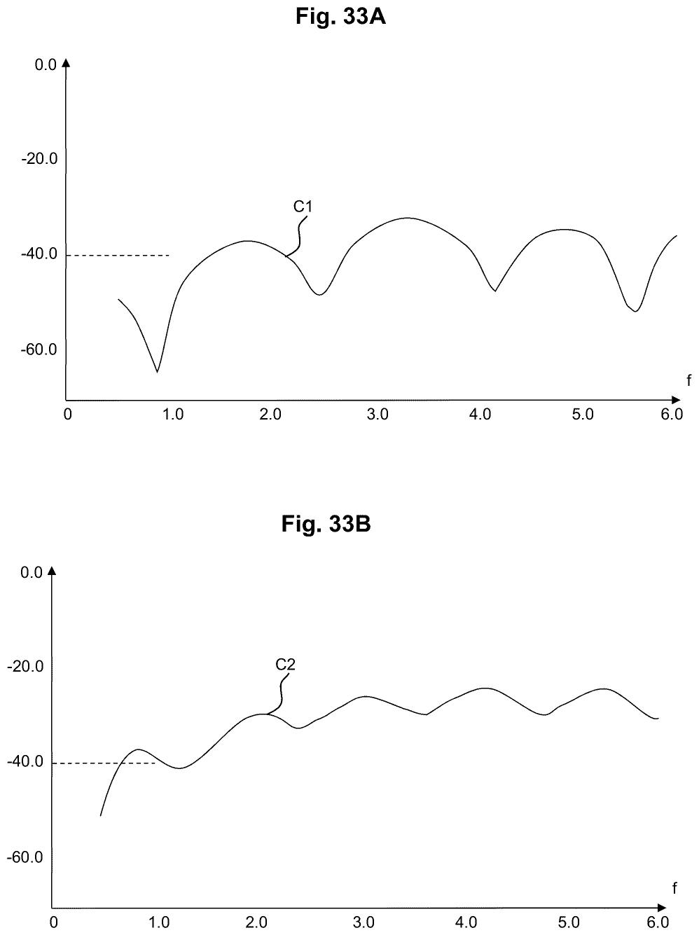

FIG. 33A schematically depicts a diagram with a curve C1 characterizing a return loss (also denoted as scattering parameter S11) over frequency according to some embodiments, wherein a single printed circuit board with an uncut signal track or transmission line for transmitting a radio frequency signal is used.

FIG. 33B schematically depicts a diagram with a curve C2 characterizing a return loss (also denoted as scattering parameter S11) over frequency according to some embodiments, wherein a printed circuit board assembly according to FIG. 32 is used. It can be seen that the return loss is below about −30 dB up to a frequency of about 2 GHz, and only slightly increasing in the frequency range between 2 GHz and 6 GHz. Hence, the printed circuit board assembly according to FIG. 32 may be used in many fields of application.

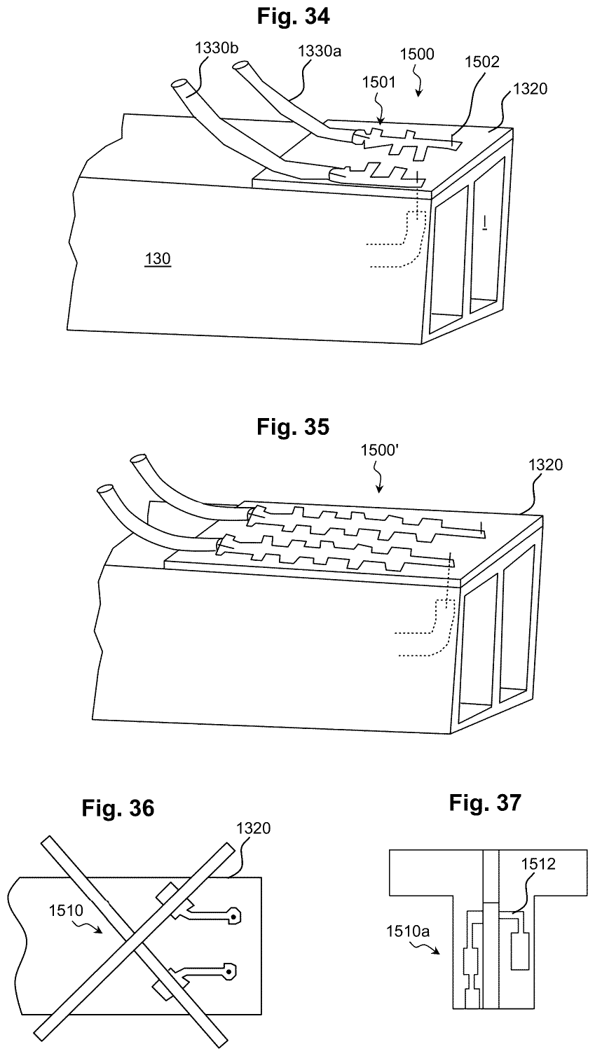

FIG. 34 schematically depicts a perspective view of aspects of an apparatus according to some embodiments. A connecting element 1320 as exemplarily explained above with respect to FIG. 21 is provided for connecting the cables 1330a, 1330b to the enclosure 130. In some embodiments, further circuitry 1500, for example matching networks or filters, may be provided on the connecting element 1320. In some embodiments, an inner conductor of the coaxial cables 1330a, 1330b may be connected, for example soldered, to a first terminal 1501 of the further circuitry 1500, and a second terminal 1502 of the further circuitry 1500 may protrude through an opening of the connecting element 1320 and the enclosure, for example into the interior of the enclosure 130, for example similar to the inner conductor 1332 of the coaxial cable 1330a of FIG. 22.

In some embodiments, the further circuitry 1500 may comprise radio frequency circuitry (circuitry for processing radio frequency signals), such as power splitters, matching sections, filters, direct current groundings, lightning protections, etc.

FIG. 35 schematically depicts a perspective view of aspects of an apparatus according to some embodiments, wherein a low-pass filter is provided on the connecting element 1320.

In some embodiments, one or more connecting elements 1320 may also be used to place diverse radiating elements on them, for example by soldering. In that case, the use of cables may be, for example completely, unnecessary.

Moreover, in some embodiments, different kinds of radio frequency connectors can be placed onto the connecting element 1320, for example interfacing potentially with radiating elements, which, in some embodiments, may also be equipped with connectors. In some embodiments, other types of modules or sub-modules, for example alternatively or additionally to the radiating elements, may be connected to the connecting element 1320 using one or more radio frequency connectors arranged on the connecting element 1320.

FIG. 36 schematically depicts a top view of aspects of an apparatus according to some embodiments. A radiating element 1510 is arranged on a surface of the connecting element 1320.

FIG. 37 schematically depicts a side view of the radiating element 1510 of FIG. 36. As can be seen, radio frequency circuitry 1512 may be arranged at the radiating element 1510, for example on a side surface of a base section 1510a of the radiating element 1510.

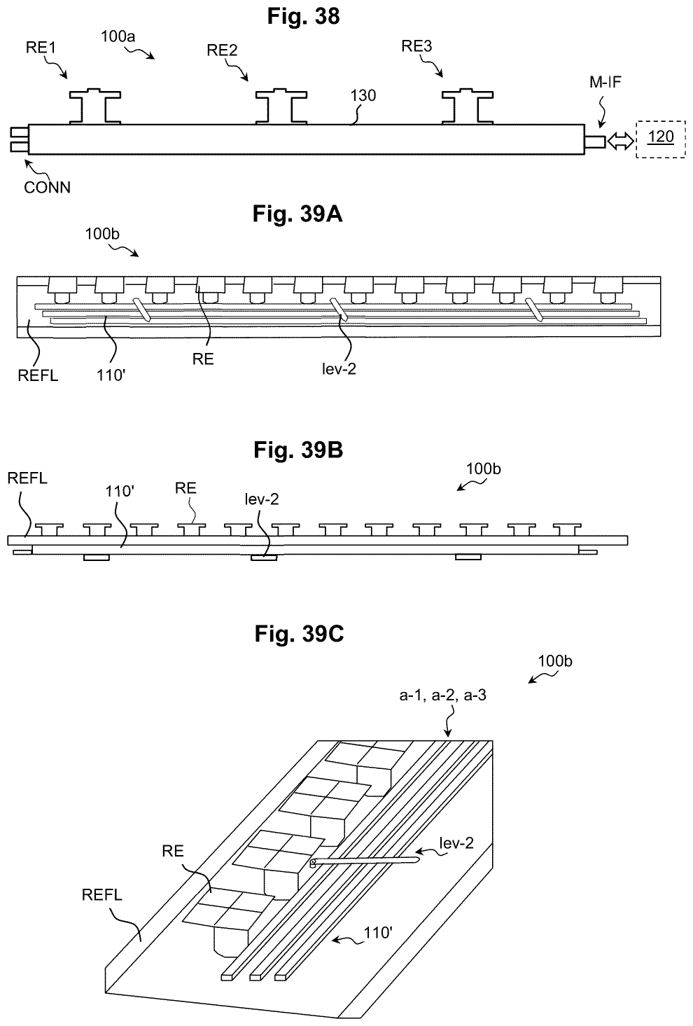

FIG. 38 schematically depicts a side view of an apparatus 100a according to some embodiments. The apparatus 100a comprises an enclosure 130 and three radiating elements RE1, RE2, RE3 arranged on an outer surface of the enclosure 130. In some embodiments, at least one of the three radiating elements RE1, RE2, RE3 may be connected to the enclosure 130 using the connecting element 1320 as exemplarily disclose above with reference to FIG. 21-28B, 34, 35.

In some embodiments, the radiating elements RE1, RE2, RE3 may be configured to radiate (transmit and/or receive) radio frequency energy at two different polarizations, for example +45 degrees and −45 degrees.

In some embodiments, at least one connector CONN for providing an input and/or output signal to/from the apparatus 100a may be provided. In other words, in some embodiments, a radio frequency signal may be provided to the apparatus 100a using the at least one connector CONN, whereas in some other embodiments, a radio frequency signal may be provided by the apparatus 100a at the at least one connector CONN.

In some embodiments, the apparatus 100a may comprise at least one phase shifting stage 110-1, 110-2, 110-3 as exemplarily discussed above with reference to FIG. 1 et seq.

In some embodiments, the apparatus 100a may comprise at least one phase shifter module 112-1 as exemplarily discussed above with reference to FIG. 1 et seq.

In some embodiments, the apparatus 100a may comprise at least one dielectric phase shifter.

In some embodiments, the apparatus 100a may comprise a mechanical interface M-IF, for example to drive one or more components of the at least one phase shifting stage 110-1, 110-2, 110-3 and/or of the at least one phase shifter module 112-1. As an example, in some embodiments, where the apparatus 100a comprises a lever-arm system as for example explained above with reference to FIGS. 12 and/or 16, mechanical energy may be applied to the interface M-IF to move at least one arm a-1 and/or at least one lever lev-1 of the lever-arm system for modifying a phase shift as provided by the at least one phase shifting stage 110-1, 110-2, 110-3 and/or of the at least one phase shifter module 112-1. In other words, in some embodiments, a drive system 120 may be provided external to the enclosure 130 and may be configured to drive the components of the mechanical interface M-IF.

In some embodiments, the drive system 120 for actuating at least one movable (translation and/or rotation) element of the at least one phase shifting stage 110-1, 110-2, 110-3 and/or of the at least one phase shifter module 112-1 may be integrated into the enclosure 130.

FIG. 39A schematically depicts a perspective view of an apparatus 100b according to some embodiments having a plurality of radiating elements. The apparatus 100b may comprise a phase shifting network 110′ comprising at least one phase shifting stage 110-1, 110-2, 110-3 and/or of the at least one phase shifter module 112-1, for example with a lever-arm system. In some embodiments, the phase shifting network 110′ is configured to provide the radiating elements with phase shifted portions of an input signal, for example similar to FIG. 10.

In some embodiments, the apparatus 100b may also comprise a reflector REFL.

FIG. 39B schematically depicts a side view of the apparatus 100b according to FIG. 39A, and FIG. 39C schematically depicts a perspective view of aspects of the apparatus 100b of FIG. 39A. In some embodiments, a part of a casing of an antenna module may be used as the reflector REFL.

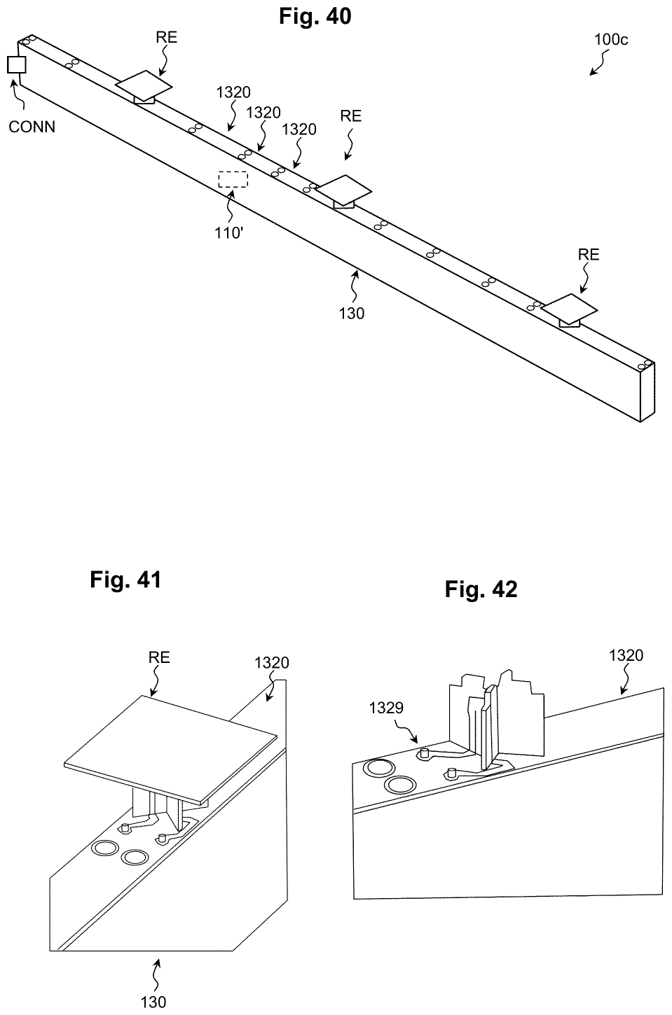

FIG. 40 schematically depicts a perspective view of an apparatus 100c according to some embodiments. The apparatus 100c comprises an enclosure 130 and a plurality of connecting elements 1320 only three of which are explicitly referenced in FIG. 40 for the sake of clarity. In some embodiments, the plurality of connecting elements 1320 may be used to connect cables (not shown in FIG. 40), for example coaxial cables, to the apparatus 100c, and/or for connecting radiating elements RE to the apparatus 100c.

In some embodiments, the radiating elements RE may be configured to process two polarizations, for example +45 degrees and −45 degrees.

In some embodiments, the plurality of connecting elements 1320 may be used for connecting the radiating elements RE to at least one phase shifting network 110′ comprising for example at least one phase shifting stage 110-1, 110-2, 110-3 and/or at least one phase shifter module 112-1. In some embodiments, the phase shifting network 110′ may be provided in an interior of the enclosure 130.

In some embodiments, the plurality of connecting elements 1320 may also comprise circuitry (not shown in FIG. 40) for processing radio frequency signals, such as for example matching networks, filters, DC grounding means, and the like.

FIG. 41 schematically depicts a perspective view of aspects of the apparatus 100c of FIG. 40, and FIG. 42 schematically depicts a further perspective view of aspects of the apparatus 100c of FIG. 40.

Reference sign 1329 symbolizes a pin which may in some embodiments be used to solder tracks from the connecting element 1320 to an internal carrier, for example internal printed circuit board, which may, in some embodiments, for example comprise one or more phase shifting stages 110-1, 110-2, 110-3.

In the following, exemplary aspects and advantages are listed which may at least sometimes be enabled by some exemplary embodiments.
a) in some embodiments, a monolithic enclosure 130 may be provided, which may comprise a length of 2 meters or more,
b) carrier boards, for example printed circuit boards 140a, 140b (FIG. 32) may be provided, which may comprise a length of 2 meters or more,
c) radio frequency cables may be saved, because in some embodiments, radio frequency signals may be transmitted by one or more printed circuit boards, and in some embodiments, radiating elements RE may be connected to an output of a phase shifting stage using the connecting element(s) 1320,
d) one or more phase shifting stages 110-1, 110-2, 110-3 and/or phase shifter modules 112-1, 112-2, . . . may be integrated into an enclosure 130,
e) additional radio frequency signal processing functionality may be provided, for example by additional circuitry 1500, for example on the connecting element(s) 1320,
f) radiating elements RE may be connected to the connecting element(s) 1320, for example using radio frequency connectors and/or soldering,
g) complexity may be reduced, as compared to some conventional approaches, because a number of radio frequency cables may be reduced or, in some embodiments, no radio frequency cables are used,
h) in some embodiments, efficient scalability is provided, as printed circuit boards 140a, 140b may be connected to each other, enabling large board structures which may be configured to supply more than for example 12 radiating elements,
i) tin plating of the enclosure is not used in some embodiments, because the cables 1330a, 1330b may efficiently be connected to the enclosure 130 using one or more connecting elements 1320, rather, in some embodiments, non tin-plated aluminium may be used for the enclosure,
j) several enclosure parts 130a, 130b may be arranged and connected together, using for example a connecting element 132 (FIG. 17),
k) cabling errors may be avoided, as few or now cables are used in some embodiments,
l) high degree of modularity can be attained in some embodiments, where the radiating elements may for example be connected to the enclosure 130 using connecting elements 1320 and radio frequency connectors provided on the connecting elements 1320, this may also enable to ease repair and maintenance works. In some embodiments, the enclosure 130, for example with an integrated phase shifter network 110′, may be easily separated from the remaining components, which may for example form a multiband antenna system. As an example, in some embodiments, the integrated phase shifter network 110′ may be fully tested before mounting it in the field
m) a radio frequency performance of a system, for example an antenna, comprising the apparatus 100, 100a, 100b, 100c may be improved, as a number of connection points may be largely reduced, as losses related to cable lengths may be deleted, as a reproducibility is improved (less parts=reduced tolerance chain, benefit from the high reproducibility of printed circuit board manufacturing, etc.)
n) enhanced passive intermodulation (PIM) performance and PIM stability,
o) a use of automated deposit, assembly and soldering manufacturing processes is enabled,
p) weight reduction
q) cost reduction.

Some embodiments relate to a phase shifter comprising at least one apparatus 100, 100a, 100b, 100c according to the embodiments. In some embodiments, the apparatus 100, 100a, 100b, 100c may be integrated to or connected with a plurality of antenna or radiating elements, wherein for example a phased array antenna system may be provided.

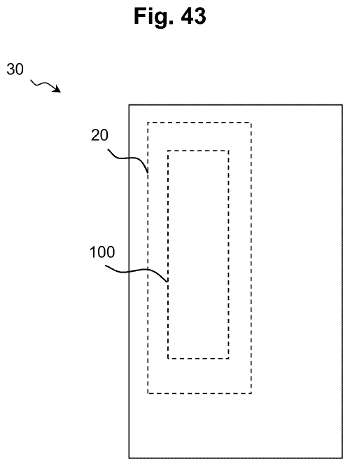

FIG. 43 schematically depicts a block diagram of a base station 30 according to some embodiments. The base station 30 comprises at least one apparatus 100 according to the embodiments. In some embodiments, the base station 30 may comprise an antenna array 20 according to the embodiments.

In some embodiments, an antenna beam tilt position may be controlled using the 100, 100a, 100b, 100c according to the embodiments.

1. An apparatus for processing radio frequency signals, comprising a first phase shifting stage configured to receive an RF signal and to provide n1 many, with n1>=2, phase-shifted portions of the RF signal, and at least a second phase shifting stage configured to receive the n1 many phase-shifted portions of the RF signal and to provide n2 many, with n2>=n1, phase-shifted portions the RF signal based on the received n1 many phase-shifted portions of the RF signal, wherein a phase shift applied by the second phase shifting stage to the n1 many phase-shifted portions of the RF signal is based on at least one phase shift applied by the first phase shifting stage to the n1 many phase-shifted portions of the RF signal with respect to the RF signal.

2. The apparatus according to claim 1, wherein the first phase shifting stage is configured to apply a positive phase shift by a first phase shift value to at least a first portion of the radio signal to obtain a first phase-shifted portion of the RF signal and to apply a negative phase shift by the first phase shift value to at least a second portion of the radio signal to obtain a second phase-shifted portions of the RF signal.

3. The apparatus according to claim 2, wherein the second phase shifting stage is configured to apply a positive phase shift by a second phase shift value to at least a first portion of the first phase-shifted portion of the RF signal and to apply a negative phase shift by the second phase shift value to at least a second portion of the first phase-shifted portion of the RF signal.

4. The apparatus according to claim 3, wherein the second phase shift value is a multiple or a fraction of the first phase shift value.

5. The apparatus according to claim 1, wherein the first phase shifting stage and the second phase shifting stage each comprises at least one phase shifter module configured to split an input signal into at least two phase shifted output signals.

6. The apparatus according to claim 5, wherein the phase shifter module comprises a first port for receiving the input signal, a second port for providing a first one of the at least two output signals, and a third port for providing a second one of the at least two output signals, wherein the phase shifter module further comprises at least one coupling element arranged movably with respect to the first port, the second port and the third port, the at least one coupling element coupling the first port with the second port and the third port with a predetermined phase shift based on a relative position of the at least one coupling element with respect to the first port.

7. The apparatus according to claim 6, wherein the apparatus is configured to move a coupling element of the phase shifter module of the first phase shifting stage and a coupling element of the phase shifter module of the second phase shifting stage at different speeds.

8. The apparatus according to claim 6, wherein each one of the first port and the second port and the third port is assigned a respective transmission line segment, wherein the coupling element is configured to establish an electromagnetic coupling between the transmission line segment associated with the first port and the transmission line segment associated with the second port and between the transmission line segment associated with the first port and the transmission line segment associated with the third port.

9. The apparatus according to claim 7, wherein the apparatus is configured to move coupling elements of the phase shifter module of the first phase shifting stage with a same relative speed with respect to coupling elements of phase shifter modules of the second phase shifting stage.

10. The apparatus according to claim 7, wherein the apparatus comprises a drive system driving a movement of the coupling elements.

11. The apparatus according to claim 10, wherein the drive system comprises a lever-arm system having a plurality of arms wherein each arm is coupled to one or more coupling elements of a same phase shifting stage, and wherein the arms are rotatably connected to at least one lever.

12. The apparatus according to claim 11, wherein the apparatus is configured to move a) the at least one lever and/or b) at least one of the plurality of arms to drive a movement of the plurality of arms.

13. The apparatus according to claim 10, wherein the drive system comprises a pulley system having a plurality of pulleys, wherein each pulley is coupled to one or more coupling elements of a same phase shifting stage, and wherein the apparatus is configured to drive different pulleys at a respective different speed.

14. The apparatus according to claim 13, wherein at least one pulley of the plurality of pulleys comprises a wire for driving a movement of one or more coupling elements of a same phase shifting stage.

15. The apparatus according to claim 10, wherein the drive system comprises a rack and pinion system having a plurality of racks, wherein each rack is coupled to one or more coupling elements of a same phase shifting stage, wherein the apparatus is configured to drive different racks at a respective different speed.

16. The apparatus according to claim 1, further comprising an enclosure, wherein the enclosure comprises at least a first part and a second part, wherein the first part is connected to the second part via a connecting element configured to provide a capacitive coupling between the first part and the second part.

17. The apparatus according to claim 16, wherein the connecting element comprises a printed circuit board having a plurality of electrically conductive vias, at least one electrically conductive layer connected to the plurality of electrically conductive vias, and at least one electrically insulating layer arranged on the at least one electrically conductive layer.

18. The apparatus according to claim 17, wherein the printed circuit board comprises at least one opening.

19. The apparatus according to claim 1, further comprising at least two printed circuit boards mechanically connectable and/or connected to each other using form closure.

20. A phase shifter comprising at least one apparatus according to claim 1.

21. An antenna array comprising at least one apparatus according to claim 1.

22. A base station comprising at least one apparatus according to claim 1.

23. A method for processing radio frequency signals using an apparatus comprising a first phase shifting stage configured to receive an RF signal and to provide n1 many, with n1>=2, phase-shifted portions of the RF signal, and at least a second phase shifting stage configured to receive the n1 many phase-shifted portions of the RF signal and to provide n2 many, with n2>=n1, phase-shifted portions of the RF signal based on the received n1 many phase-shifted portions of the RF signal, the method comprising: receiving, by means of the first phase shifting stage, an RF signal, providing, by means of the first phase shifting stage, n1 many phase-shifted portions of the RF signal, wherein a phase shift applied by the second phase shifting stage to the n1 many phase-shifted portions of the RF signal is based on at least one phase shift applied by the first phase shifting stage to the n1 many phase-shifted portions of the RF signal with respect to the RF signal.
